(19) United States
(12) Patent Application Publication
(10) Pub. No.: US 2017/0136747 A1
(43) Pub. Date: May 18, 2017

(54) ARTICLES COMPRISING LOW TEMPERATURE HEAT-SEALABLE POLYESTER

(71) Applicant: E I DU PONT DE NEMOURS AND COMPANY, Wilmington, DE (US)

(72) Inventors: JOSE MARIA TORRADAS, WEST CHESTER, PA (US); DIANE MCCAULEY HAHM, BOOTHWYN, PA (US); ALICIA MARIE CASTAGNA, FRAMINGHAM, MA (US)

(21) Appl. No.: 15/349,216

(22) Filed: Nov. 11, 2016

Related U.S. Application Data
(60) Provisional application No. 62/255,631, filed on Nov. 16, 2015.

(51) Int. Cl. B32B 27/36; B29C 47/00; B32B 27/34; B29B 9/06; B32B 7/12; B32B 27/08

(52) U.S. Cl. CPC B32B 27/36; B32B 7/12; B32B 27/08; B32B 27/34; B29B 9/06; B29C 47/0021; B32B 2307/7242; B32B 2439/06; B29B 2009/165

(57) ABSTRACT

An article such as a film or sheet comprises a heat-sealable polyester composition having an amorphous processing window ranging from a Tg in the range of about 40 to about 70° C., to a Tcg in the range of about 70 to about 150° C. The composition comprises poly(trimethylene furandicarboxylate) homopolymer or copolymer, or a blend of poly(trimethylene furandicarboxylate) homopolymer or copolymer with other polymers such as poly(alkylene furandicarboxylate) homopolymer or copolymer or poly(alkylene terephthalate) homopolymer or copolymer. The resulting composition is heat-sealable at low temperatures, and exhibits superior barrier properties compared to poly(ethylene terephthalate).

### CROSS-REFERENCE TO RELATED APPLICATION

This application claims priority under 35 U.S.C. §119 to U.S. Provisional Appln. No. 62/255,631, filed on Nov. 16, 2015, which is incorporated herein by reference in its entirety.

### FIELD OF THE INVENTION

Provided herein are articles such as films or sheets comprising a heat-sealable polyester composition having an amorphous processing window ranging from a Tg in the range of about 40 to about 70° C., to a Tcg in the range of about 70 to about 150° C. The polyester composition comprises poly(trimethylene furandicarboxylate) homopolymer or copolymer, and it is heat-sealable at lower temperatures while retaining good barrier properties.

### BACKGROUND OF THE INVENTION

The packaging industry uses a wide variety of films and containers prepared from various thermoplastic resins and compositions for packaging food and non-food products. These packages provide adequate protection (for example, protection from mechanical damage, barriers to air or moisture, etc.) of the product contained within until the consumer is ready to use the product. It is also desirable for the package to be designed to allow the consumer easy access to the product at the appropriate time. Packages such as pouches may be prepared from plastic films, especially multilayer film structures. Often, packages consist of rigid containers made from metal (particularly aluminum), paper, fiberboard or plastic (for example, polypropylene, crystallized polyethylene terephthalate (CPET) and high-impact polystyrene (HIPS)) with a lidding film sealed to the container. It is desirable that the seal between the container and the lidding film provide a strong hermetic seal to protect the product and that the seal is easily and cleanly peeled by the consumer.

Barrier properties are one of the key requirements for polymers used in packaging applications to protect the contents and provide desired shelf-life. Barrier to oxygen and to water are the most relevant, although barrier to light and chemicals are sometimes relevant too. The prevention of oxygen permeation, for example, inhibits oxidation and microbial growth, whereas prevention of water vapor permeation retains liquid content. Many polymers have emerged for these applications, such as poly(ethylene terephthalate) (PET), polyethylene (PE), poly(vinyl alcohol) (PVOH), ethylene vinyl alcohol polymer (EVOH), polyacrylonitrile (PAN), polyethylene naphthalene) (PEN), polyamide derived from adipic acid and m-xylenediamine (MXD6) and poly(vinylidene chloride) (PVdC), and may include additives like nanofillers or oxygen scavengers to enhance barrier properties. However, most of these polymers suffer from various drawbacks. For example, high density polyethylene (HDPE) and low density polyethylene (LDPE) have good water vapor barrier properties, but poor oxygen barrier properties. EVOH exhibits good oxygen barrier properties at low humidity levels, but fails at high levels of humidity. PET has relatively high tensile strength, but is limited by moderate water and gas barrier properties.

Poly(ethylene terephthalate), and copolyesters thereof (e.g., copolyesters with isophthalate (I) or cyclohexane dimethanol (CHDM) to make PET-I, 2G—CHDM/T or 2G—CHDM/T-I or PETG) are known to be useful for packaging goods or foods that are sensitive to flavor loss or absorbing ambient flavors and odors, i.e., flavor scalping. For example, see U.S. Pat. No. 4,578,437. These resins are also useful to provide grease resistance. In addition, these polyesters provide a moderate barrier to the transmission of oxygen or water vapor, and an excellent barrier to carbon dioxide.

In packaging and other applications, heat-sealing is often used to join thermoplastic parts. This is done by applying heat to the surfaces to be joined to soften or melt them while applying some pressure to the place where they need to be joined. Most commonly the heating is carried out by contacting the surfaces opposite those to be joined with a hot object, such as a hot bar, or by heating the surfaces with hot air, infra-red radiation, ultrasonic, or induction heating.

The temperature range for heat sealing polymer films is typically bounded by the glass transition temperature (T_{g}) and the crystallization temperature (T_{c}). Above the glass transition temperature, the polymer has sufficient mobility to form entanglements across the interface of the film, while at the crystallization temperature that mobility is lost. The interface is commonly heated using a hot seal bar on the opposite sides of the surfaces to be joined. In this case, seal bar temperatures are higher than the actual sealing temperature, in order to account for the temperature drop through the material to the interface of the seal. Different heating types (i.e., induction, ultrasound, infra-red radiation) can be used to introduce the thermal energy to join the polymer.

The speed at which one can heat the surfaces to be joined to the proper temperature for joining often determines the speed at which one can heat-seal the surfaces. High-speed heat-sealing is important because many such operations are high-volume, continuous operations where slow heat-sealing speeds significantly increase costs.

It would be desirable to seal polyesters using thermal sealing equipment at fast sealing speeds, and still achieve strong seals. This has traditionally been difficult to achieve with PET homopolymer or copolymer because of the high glass transition temperature (Tg) of these compositions, typically greater than about 70° C. Amorphous (non-crystalline) polyester films or articles will not form heat seals with themselves until the temperature of the two seal-forming surfaces are raised to a range above the glass transition.

Hence, there is a need for a new polymer that can be sealed at low sealing temperatures. There is also a need for a polymer with improved oxygen, carbon dioxide, and moisture barrier properties compared to PET that can be easily heat-sealed at low sealing bar temperatures and fast sealing speeds, yet still produces seals of high strength. Especially for use in packaging, it would be preferred that such polymer produce clear parts and films.

U.S. Patent Application Publication US2014/0205786 and Intl. Patent Appln. Publn. No. WO2016/123209 (claiming priority from U.S. Patent Application Ser. No. 62/108,636) describe films comprising a layer of poly(trimethylene furandicarboxylate), also known as poly(trimethylene furanoate).

### SUMMARY OF THE INVENTION

Poly(trimethylene furandicarboxylate) (PTF) demonstrates flexibility as a sealing material. This material can seal to itself over a broad range of temperatures and is not limited by crystallization as other polyesters are. This broad window enables PTF to seal to other polyesters at different extremes of the seal temperature window. In addition to providing seal functionality to a multi-layer structure, PTF layers also provide barrier properties as described in U.S. Patent Application Publication US20124/025786. This combined barrier/sealant functionality can provide tremendous advantages by reducing the number of layers needed in a conventional multilayer barrier structure, which in turn reduces material costs, energy costs, and package weights.

Accordingly, provided herein is an article comprising a sealant layer comprising a heat-sealable polyester composition having an amorphous processing window ranging from a glass transition temperature, Tg, in the range of about 40 to about 70° C., preferably about 50 to about 60° C., to a peak crystallization temperature from the amorphous state Tcg in the range of about 70 to about 150° C., preferably about 90 to about 130° C., or about 100 to about 120° C., wherein the polyester composition comprises a polymer comprising poly(trimethylene furandicarboxylate).

The article may comprise a multilayer gas barrier film comprising a sealant layer comprising the poly(trimethylene furandicarboxylate) composition.

Further provided is an article comprising a multilayer structure for a package, comprising in order from outside the package to inside the package, an external layer, optionally at least one inner layer that is a bulking layer, barrier layer or adhesion layer, and at least one sealant layer comprising the polytrimethylene furandicarboxylate polymer composition.

Yet further provided is a process for heat-sealing two thermoplastics wherein the two thermoplastic surfaces are sealed to one another by the application of heat and pressure, wherein the improvement comprises at least one of said thermoplastics comprises a polyester composition comprising poly(trimethylene furandicarboxylate) homopolymer or copolymer, or copolymer formed from the respective monomers.

Yet further provided is an article wherein two thermoplastic surfaces have been heat-sealed, wherein at least one of said thermoplastic surfaces comprises a polyester composition comprising poly(trimethylene furandicarboxylate) homopolymer or copolymer, or a copolymer formed from the respective monomers.

Finally, an article is provided that is a package, wherein the heat-sealable polyester composition comprising the polytrimethylene furandicarboxylate polymer composition faces the inside of the package and is in contact with the contents of the package. The package may comprise a film, sheet, pouch, sachet, bag, thermoformed article, lid, container, blister pack, coated substrate or multilayer laminate.

### DETAILED DESCRIPTION

For purposes of the following disclosure the following definitions are to apply.

All publications, patent applications, patents, and other references mentioned herein are incorporated by reference in their entirety. Unless otherwise defined, all technical and scientific terms used herein have the same meaning as commonly understood by one of ordinary skill in the art to which this invention belongs. In case of conflict, the specification, including definitions, will control.

Although methods and materials similar or equivalent to those described herein can be used in the practice or testing of the invention, suitable methods and materials are described herein.

Unless stated otherwise, all percentages, parts, ratios, etc., are by weight.

Moreover, the amounts of all components in a polymer or composition are complementary, that is, the sum of the amounts of all the components is the amount of the entire polymer composition. For example, when an ethylene copolymer is described by specifying the weight percentage of a copolymerized comonomer, the total of the weight percentages of the copolymerized ethylene, the copolymerized comonomer, and the other copolymerized comonomers, if any, is 100 wt %.

When an amount, concentration, or other value or parameter is given as either a range, preferred range or a list of lower preferable values and upper preferable values, this is to be understood as specifically disclosing all ranges formed from any pair of any lower range limit or preferred value and any upper range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

The transitional phrase “consisting essentially of” limits the scope of a claim to the specified materials or steps and those that do not materially affect the basic and novel characteristic(s) of the claimed invention. Where applicants have defined an invention or a portion thereof with an open-ended term such as “comprising,” unless otherwise stated the description should be interpreted to also describe such an invention using the term “consisting essentially of”.

Use of “a” or “an” are employed to describe elements and components of the invention. This is merely for convenience and to give a general sense of the invention. This description should be read to include one or at least one and the singular also includes the plural unless it is obvious that it is meant otherwise.

In this specification, the concepts have been disclosed with reference to specific embodiments. However, one of ordinary skill in the art appreciates that various modifications and changes can be made without departing from the scope of the invention as set forth in the claims below.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all embodiments.

It is to be appreciated that certain features are, for clarity, described herein in the context of separate embodiments, may also be provided in combination in a single embodiment. Conversely, various features that are, for brevity, described in the context of a single embodiment, may also be provided separately or in any sub combination. Further, references to values stated in ranges include each and every value within that range.

In describing certain polymers it should be understood that sometimes applicants are referring to the polymers by the monomers used to produce them or the amounts of the monomers used to produce the polymers. While such a description may not include the specific nomenclature used to describe the final polymer or may not contain product-by-process terminology, any such reference to monomers and amounts should be interpreted to mean that the polymer comprises copolymerized units of those monomers or that amount of the monomers, and the corresponding polymers and compositions thereof.

The term “homopolymer” in the context of polymers such as polyethylene or polypropylene refers to a polymer that comprises only copolymerized units of the named monomer. The term “copolymer” means a polymer comprising two or more comonomers.

The term “homopolymer” in the context of polyesters refers to a polymer polymerized from two monomers (e.g., one type of glycol and one type of diacid (or methyl ester of diacid)), or more precisely, a polymer containing one repeat unit. The term “copolymer” means a polyester polymer polymerized from three or more monomers (such as more than one type of glycol and/or more than one type of diacid), or more precisely, a polymer containing two or more repeat units, and thereby includes terpolymers or even higher order copolymers.

The term “distinct polyesters” refers to polyesters prepared from monomers wherein at least one monomer is different between the polyesters.

The term “physical blend” refers to a uniform, intimate mixture of two or more polymers formed by melt blending and optionally compounding.

“Tg” refers to the glass transition temperature of a polymer. Typically, this is measured by using a differential scanning calorimeter (DSC) per ASTM D3417 at a heating rate of 10° C./min for heating and cooling, and the mid-point of inflection in the heat flow vs. temperature curve is reported. “Tcg” refers to the peak temperature of crystallization from the amorphous state, measured by using a DSC per ASTM D3417 at a heating rate of 10° C./min for heating and cooling.

As used herein, the term “amorphous processing window” refers to the temperature range between a polymer's glass transition temperature, Tg, and the peak temperature of crystallization from the amorphous state, i.e., the cold crystallization temperature, Tcg.

Thermally activated or heat sealable sealant compositions soften when heat is applied, adhere to a substrate at the elevated temperature and then harden while retaining adhesion as the temperature is lowered. Unlike pressure-sensitive adhesions that remain tacky at ambient temperatures, thermally activated sealants are not tacky unless heated. Thermally activated sealant compositions as described herein and films comprising the compositions can be applied at relatively low temperatures, from 90 to 180° C. and preferably from 100 to 160° C. or from 120 to 160° C. The heat seal initiation temperature is defined herein as the temperature at which the thermally sealed material provides strong seal strength, defined herein as at least 1000 grams-force/inch. The polymer compositions described herein may exhibit seal initiation temperatures that are lower than the seal initiation temperatures of polymeric sealants known in the art. Peel strength is the amount of force required to remove to a film from a substrate.

Peel strength may be impacted by the conditions to which the sealed materials are exposed, such as temperature, humidity, and the length of time they are adhered to the surface. Peel strength can either “age-up” (increase) or “age-down” (decrease) between the time of application and removal of the film. Although some deviations from the initial “green peel strength” can be tolerated, significant age-up or age-down could result in undesired properties. Therefore, it is desirable that the peel strength remain stable over extended periods of time and a variety of weather exposures.

Aging occurs as polymer chains reorganize to lower free volume when stored below Tg. The effect of aging is exacerbated the closer the storage temperature is to Tg. A typical manifestation of this phenomenon is a large peak at approximately the Tg of the material observed by DSC. This enthalpy relaxation process requires additional energy to traverse the glass transition temperature to achieve chain mobility sufficient to form entanglements across the film interface, resulting in a seal. Aging can occur in the film prior to heat sealing, resulting in less effective seals at a given set after the film has aged, or it can occur after heat sealing as the seal composition relaxes after heating.

When peeling a film from a substrate under stress at various angles of peel and speeds, different types of seal failure can result. Peelable heat seals commonly can be designed to have three different failure modes when peeling seal to seal or seal to differentiated substrate. Failure can be interfacial, delamination or cohesive when peeling one from the other under stress at various angles of peel and speeds. Interfacial seals are designed to fail at the heat seal interface of the selected sealing surface (i.e., the sealant layer peels cleanly away from the substrate layer). In most cases seal strength is determined by temperature, pressure and dwell time. Seals that do not peel cleanly can contaminate the contents of the package with fragments of the seal or lidding. Interfacial peelable seals are desirable to prevent such contamination. In most cases seal strength is determined by temperature, pressure and dwell time.

Cohesive seal failure by design fails within the actual sealant layer itself. When peeling the seal under stress and speed, the seal layer splits within itself and transfers a portion of the sealant material to the sealant substrate. Internal strength of the sealant material is the determining factor for actual strength of the heat seal.

Delamination heat seals are designed to fail at an internal interface of a multilayer film structure. This designed failure interface is at a chosen layer somewhere behind the actual heat seal layer in the film structure. In this case the entire sealant layer, the delamination layer and any intervening layers are removed from the remaining film as it is being peeled. Thickness and adhesion to the chosen internal layer interface will determine strength of the seal during peeling. Desirably, the adhesion of the delamination layer to the sealant layer, or intervening layer when present, is higher than the adhesion to the layer of the remaining film that it contacts.

As used herein, the term “peelably adhered” means that there is an interfacial peelable seal between the sealant layer and the substrate, such that the film can be peeled cleanly from the substrate by hand. The peel strength of the sealant should be sufficient to withstand handling, further processing, transportation and installation, but desirably is low enough such that the films can be removed from the substrate by hand with relative ease. “Frangible seal” is used interchangeably with “peelable seal”, but may refer more specifically to seals that are separated by internal pressure resulting from pressurizing the contents of the package by squeezing, heating or the like. Preferably, the peel strength for a peelable seal is less than about 1000 g-force/inch (5.9 N/15 mm), such as from about 200 (1.16 N/15 mm) to about 1000 g-force/inch (5.9 N/15 mm), preferably from about 400 (2.32N/15 mm) to about 900 g-force/inch (5.21 N/15 mm).

While in some embodiments it is necessary for the sealant to be peelable from the substrate, the sealant composition must also be strongly or irreversibly adhered to other structure layers in the film so that the film maintains structural integrity throughout its use in protecting the substrate and when the film is peeled from the substrate. In other embodiments, the sealant layer desirably forms a lock seal between the film and the substrate or to itself. As used herein, the terms “irreversibly adhered” and “lock seal” and “permanent seal” means that adjacent layers cannot be separated by hand and the strength of the seal between the layers is such that the layers cannot be separated without damage to one or both of the layers. The mechanism of the rupture may be through the cohesive or adhesion failure of the sealant, or of one or more layers adjoining the sealant; or through tearing the sealed substrate; or by a combination of these mechanisms. Preferably, the peel strength between the sealant layer and the structure layer(s) of the film or in a in a lock seal of the sealant layer to a substrate is greater than about 1000 g-force/inch (5.9 N/15 mm), more preferably greater than about 1500 g-force/inch (8.7 N/15 mm).

The PTF polymer composition disclosed herein can produce seals that are peelable and/or permanent. The polymer compositions or sealants disclosed herein may form peelable seals when heated at temperatures that span a wider range than the range of temperatures at which polymer sealants known in the art may be heated to form a peelable seal, while still being able to form lockup seals in yet another higher temperature range.

Optimization of seal strength for a given sealant may depend on variables such as sealing temperature; the thickness and the thermal transfer coefficients of the film and sealant; the dwell time and sealing pressure; crystallinity of the sealant; and the like. A quantitative model illustrating the effect of several variables on seal strength is set forth in “Predicting the Heat Seal Performance of Ionomer Films” by Barry A. Morris, presented at SPE ANTEC 2002, May, 2002, San Francisco, Calif. It also depends on the substrate to which it is sealed.

The approximate relative temperature ranges disclosed herein for forming peelable and permanent seals may decrease in predictive value if any of the variables relevant to seal strength is varied so as to affect the interfacial surface temperature of the sealants at the moment of sealing. The sealing temperature ranges disclosed herein represent approximations and guidelines that are intended to be adjusted as appropriate to compensate for routine variations in the equipment used and other conditions of sealing, such as pressure, dwell time, etc. For instance, if the total film gauge is thicker than described in the examples, or the line speed of the sealing machine is increased, or the dwell time for the seal bars is shortened, then the seal temperatures could increase beyond the approximate ranges described for both frangible and lock seals.

The PTF composition exhibits a temperature range for forming a peelable seal to PET that is relatively lower than the temperature range at which it forms a lock seal to PET. The range of temperatures over which the polymer sealants may form peelable seals spans at least about 15° C., at least about 20° C., at least about 25° C., at least about 30° C., or at least about 35° C. Depending on the substrate, forming a peelable seal may be accomplished with sealing temperatures of about 100 to about 130° C. or about 110° to about 130° C. To form a lock seal, the sealing temperature may be greater than about 130° C. up to about 180° C. or about 130° C. to about 160° C.

It may be desirable that packaging solutions, e.g. bags or pouches, exhibit a so-called “burst peel” opening behavior. A package exhibiting burst peel is a package that opens from inside by a cohesive failure mechanism in the sealant layer, such as at the boundary between two film portions that are sealed to each other, when an initial opening force is applied to the seal. In the sealant layer, a resulting initial tear then propagates through the sealant and, often, a delamination layer until it encounters the interface between the sealant or delamination layer and an adjacent layer. At this point, the tear will then propagate along the interface between both layers and continue as a delamination until the package is opened.

A representative pouch exhibiting burst peel behavior described above contains a product in the interior of the pouch, wherein the opening is heat sealed, with a seal strength characterized by an initiation peel force from about 7 or about 9 N/15 mm to about 13 N/15 mm and a peel propagation force less than about 60% of the initiation force. This provides a good seal that resists unintended opening of the pouch under normal handling conditions, but which can be opened readily when intended by initiating an initial tear which can propagate easily through the remainder of the seal.

The terms “outside” or “exterior” as used herein refers to the side of the packaging film that faces away from the contents of a package made from the film. When used to define the position of a layer in relation to another layer in the multilayer packaging film, “outside” refers to layer(s) farther away from the contents of the package than another layer, even if neither layer is a surface layer. Likewise, the term “inside” refers to the side of the packaging film that faces toward the contents of a package made from the film. When used to define the position of a layer in relation to another layer in the multilayer packaging film, “inside” refers to the layer(s) closer to the contents of the package than another layer, even if neither layer is a surface layer. A surface layer has only one face of the layer in contact with another layer. The term “outside surface layer” refers to the surface layer farthest away from the contents of a package made from the film and the term “inside surface layer” refers to the surface layer closest to the contents of a package made from the film. The term “inner” as used herein refers to a non-surface layer of a multilayer structure, and has both of its faces in contact with other layers. The term “outermost” as used herein refers to the layer of a tubular film, such as prepared by blown film coextrusion, that provides the exterior surface of the tubular film, and likewise the term “innermost” refers to the interior surface layer of the tubular film. Because a tubular film prepared by a blown film process may be manipulated further after its initial formation into a package, the outermost layer of a tubular film may or may not correspond to the outside layer of a packaging film fabricated from the tubular film. Similarly, the innermost layer of a tubular film may or may not correspond to the inside layer of a packaging film fabricated from the tubular film.

The inside surface layer, or sealant layer, is the layer that provides the inside layer of a package prepared from the film and is closest to the packaged contents. It also provides a means for sealing or closing the package around the packaged product such as by heat sealing two portions of the sealant layer together or to the surface of another part of the package, such as sealing a lidding film to a thermoformed packaging component. The composition for the sealant is selected to influence the sealing capability of the inside surface layer, i.e., such that a high sealing bond strength may be achieved at a lowest possible sealing temperature.

The sealant layer of the film structure according to this invention serves to adhere the film structure to any suitable substrate or to itself, and comprises PTF homopolymers or copolymers described herein, or blends thereof, capable of fusion bonding on and to any suitable substrate or to themselves by conventional means of heat sealing.

Applicants have found that a heat-sealable polyester composition comprising poly(trimethylene furandicarboxylate) (PTF) surprisingly exhibits a broad seal window not limited by crystallization or aging, and with good sealability to other polyesters. PTF exhibits a broad amorphous processing window specifically because the Tg of the polymer is relatively low. The Tg of neat PTF homopolymer is about 55° C. and its Tcg is about 110° C. Accordingly, the amorphous processing window of PTF compositions, including PTF homopolymers, PTF copolymers and blends comprising PTF homopolymers or PTF copolymers with other polymers can range from a lower limit of about 40, or 50, or 55° C. to an upper limit of about 70, or 90, or 100, or 110, or about 120° C.

Since the temperature at which the heat-seal may be formed is lowered, films of such polymers can be processed at high heat-sealing speeds, thus lowering production costs and increasing efficiency. Additionally, the films comprising PTF exhibit improved flavor-barrier properties; good oxygen and/or carbon dioxide barrier properties over comparable films comprising nascent PET; and optical clarity.

As used herein, the term “nascent PET” refers to a PET composition that is 100% PET and has no additives. As used herein, the improvement in gas barrier properties is calculated as the ratio of the difference in gas barrier property between PTF and PET and the PET barrier value, expressed as a % value, as shown below:

$$\% Improvement = \frac{{G}_{PET} - {G}_{PTF}}{{G}_{PET}} \times 100$$

where G_{PTF} is the measured gas (oxygen, carbon dioxide or moisture) barrier value for PTF and GPET is the measured gas (oxygen, carbon dioxide or moisture) barrier value for PET. As used herein, oxygen barrier properties are measured according to ASTM D3985-05; carbon dioxide barrier properties are measured according to ASTM F2476-05; and moisture barrier properties are measured according to ASTM F1249-06. As used herein, the term “barrier” is used interchangeably with “permeation rate” or “transmission rate” to describe the gas barrier properties, with low permeation or transmission rate of a material implying that the material has a high barrier.

A PTF composition prepared by any of the methods described below comprising PTF is essentially amorphous (i.e., exhibiting essentially no crystallinity) and preferably exhibits an oxygen transmission rate (OTR) ranging from about 0.3 to about 1.5 cc-mil/100 in²-day-atm at 23° C. and dry, as measured according to a procedure similar to ASTM D3985-81. For example, an amorphous PTF film has an OTR of 5.11 cc-mil/m²-day-atm (0.33 cc mil/100 in²-day atm) at 23 C and 50% RH. Another amorphous film has OTR of 21 cc-mil/m²-day-atm (1.36 cc-mil/100 in²-day-atm), while an annealed (partially crystallized) film has OTR of 8 cc-mil/m²-day-atm (0.52 cc-mil/100 in²-day-atm) and a biaxially oriented film has OTR of 17.7 cc-mil/m²-day-atm (1.1 cc-mil/100 in²-day-atm).

For comparison, the OTR at 23° C. and 50% relative humidity for PET homopolymer is reported to be 5 cc-mil/100 in²-day-atm, while that of PTF may be 0.5 cc-mil/100 in²-day-atm. Thus, a layer of PTF in a multilayer structure may provide a 10-fold improvement in OTR over a PET layer of the same thickness.

Accordingly, the poly(trimethylene furandicarboxylate) polymer may provide a reduction of 2 to 99% in oxygen transmission (i.e. PTF may provide up to 100-fold better oxygen barrier than PET) or 11 to 99% in carbon dioxide transmission or a reduction of 3 to 99% in water vapor gas barrier properties of the structure compared to a structure wherein the poly(trimethylene furandicarboxylate) polymer replaces an equal amount by weight of nascent poly(ethylene terephthalate).

In one embodiment, the article comprising PTF as the polyester layer has an oxygen permeability rate that is at least 2 to 99% or 50 to 98% or 75 to 96% lower than that of an article comprising PET as the polyester layer. In another embodiment, the article comprising PTF as the polyester layer has a CO2 permeability rate that is at least 11 to 99% or 50 to 98 or 75 to 96% lower than that of an article comprising PET as the polyester layer. In another embodiment, the article has water vapor permeability rate that is at least 3 to 99 or 25 to 75% lower than that of an article comprising PET as the polyester layer.

Poly(trimethylene furandicarboxylate) (PTF) can be derived from 1,3-propanediol and any suitable isomer of furandicarboxylic acid or a derivative thereof, such as 2,5-furandicarboxylic acid; 2,4-furandicarboxylic acid; 3,4-furandicarboxylic acid; 2,3-furandicarboxylic acid or their derivatives. The 1,3-propanediol and polymers prepared therefrom may be preferably biologically-derived; that is, chemical compounds including monomers and polymers that are obtained from plants and contain only renewable carbon, and not fossil fuel-based or petroleum-based carbon. The 1,3-propanediol and 2,5-furandicarboxylic acid may be obtained by bacterial fermentation of a renewable feedstock such as, for example, corn syrup.

The term “PTF homopolymer” as used herein refers to a polymer substantially derived from the polymerization of 1,3-propanediol with furandicarboxylic acid, or alternatively, derived from the ester forming equivalents thereof, e.g., any reactants that can be polymerized to ultimately provide a polymer of poly(trimethylene furandicarboxylate). The term “copolymer of PTF” as used herein refers to any polymer comprising or derived from at least about 70 mole percent of copolymerized residues trimethylene furandicarboxylate and the remainder of the polymer being derived from copolymerized residues of monomers other than furandicarboxylic acid and 1,3-propanediol (or their ester forming equivalents). From a practical standpoint, the high percentage of trimethylene furandicarboxylate ensures the polymer is amorphous and thereby easier to dry.

Desirably, the PTF polymer has a heat of crystallization of less than 100 J/g or less than 10 J/g or less than 1 J/g, as measured by differential scanning calorimetry with heating rates of 10° C./min.

In one embodiment, the article comprises a sealant layer comprising a polymer composition comprising a polymer having a repeating unit of the formula:

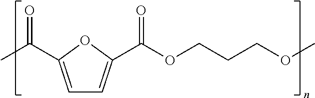

wherein n is less than 185. In a notable embodiment, n is in the range of 80 to 185.

In another embodiment, the polymer consists essentially of poly(trimethylene-2,5-furandicarboxylate) (PTF), shown below, which is derived from 1,3 propanediol and 2,5-furandicarboxylic acid and is amorphous.

The poly(trimethylene-2,5-furandicarboxylate) (PTF) as disclosed herein can have a number average molecular weight in the range of 1960-196000 or 1960-98000 or 4900-36260 daltons. Also, the PTF can have a degree of polymerization of 10-1000 or 50-500 or 25-185 or 80-185. Stated alternatively, the structure of the polymer is:

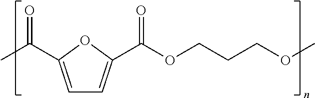

where n=10-1000 or 50-500 or 25-185 or 80-185.

In one embodiment, the polymer composition comprises a copolymer comprising units derived from 2,5-furandicarboxylate, terephthalate, and 1,3-propanediol monomer units, wherein the copolymer comprises 0.1 to 99.9% by weight of PTF repeat units based on the total weight of the copolymer.

The PTF composition may comprise a polymer blend comprising poly(trimethylene furandicarboxylate) (PTF) and poly(alkylene terephthalate) (PAT), wherein the composition comprises 1-99% or 5-75% or 10-50% by weight of PTF based on the total weight of the polymer blend. The poly(alkylene terephthalate) includes units derived from terephthalic acid and a C₂-C₁₂ aliphatic diol.

In particular, the heat-sealable PTF composition comprises poly(ethyleneterephthalate) homopolymer or copolymer and from a lower limit of about 5%, 20 or 30 weight % to an upper limit of about 80, 90 or 95% by weight of poly(trimethylene furandicarboxylate) homopolymer or copolymer, based on the total weight of poly(ethylene terephthalate) and poly(trimethylene furandicarboxylate).

The term “PET homopolymer” as used herein refers to a polymer substantially derived from the polymerization of ethylene glycol with terephthalic acid, or alternatively, derived from the ester forming equivalents thereof (e.g., any reactants which can be polymerized to ultimately provide a polymer of polyethylene terephthalate). The term “copolymer of PET” as used herein refers to any polymer comprising (or derived from) at least about 70 mole percent ethylene terephthalate and the remainder of the polymer being derived from monomers other than terephthalic acid and ethylene glycol (or their ester forming equivalents).

The PET polyesters useful in this invention include: (a) poly(ethylene terephthalate) homopolymer; and (b) PET copolymers, i.e., PET polymer modified by incorporating diacids other than terephthalic acid such as those described below, preferably isophthalic acid (I), trimellitic anhydride, trimesic acid, aliphatic diacids including adipic acid, dodecane dioic acid, CHDA (cyclohexanedicarboxylic acid), or glycols other than ethylene glycol, such as those described below, preferably cyclohexane dimethanol (CHDM), diethylene glycol, and mixtures thereof. Impurities from the recycle stream of a polyester process are another source of monomers. A preferred polyester for the blend comprises PET copolymer comprising about 1% to 15% isophthalic acid, that is, 1 to 15 wt % or 1 to 15 mol % of isophthalic acid. The level of diethylene glycol (DEG) will preferably range up to about 2 weight percent.

The composition is either a physical blend of two distinct polyesters, e.g., PET and PTF polymers, or a copolyester oligomer or polymer prepared from the respective monomers, e.g. terephthalic acid, ethylene glycol, 1,3-propane diol, furandicarboxylate and optionally other ester-forming monomers. When the polyester composition of the invention herein is a physical blend the composition will most likely exhibit at least two distinct melting points when measured using DSC per ASTM D3417. When the polyester composition is a copolyester, the amount of PTF is preferably about 40% to about 75% by weight, based on the total weight of PET and PTF.

The polymer composition may comprise a polymer blend comprising poly(trimethylene furandicarboxylate) (PTF) and other poly(alkylene furandicarboxylate) (PAF), wherein the blend comprises 0.1 to 99.9% or 5 to 75% or 10 to 50% by weight of PTF based on the total weight of the polymer blend. The poly(alkylene furandicarboxylate) includes units derived from furandicarboxylic acid and a C₂-C₁₂ aliphatic diol other than 1,3-propanediol. Notably, the blend may comprise poly(trimethylene furandicarboxylate) and poly(ethylene furandicarboxylate).

A poly(alkylene furandicarboxylate) (PAF) including PTF can be prepared from a C₂ to C₁₂ aliphatic diol and from a furandicarboxylic acid, preferably 2,5-furandicarboxylic acid, or a derivative thereof. When the diol comprises 1,3-propanediol, the PAF is a PTF polymer. In an embodiment, the aliphatic diol comprises a biologically derived C₃ diol, such as 1,3-propanediol. In a derivative of 2,5-furandicarboxylic acid, the hydrogens at the 3 and/or 4 position on the furan ring can, if desired, be replaced, independently of each other, with —CH₃, —C₂H₅, or a C₃ to C₂₅ straight-chain, branched or cyclic alkane group, optionally containing one to three heteroatoms selected from the group consisting of O, N, Si and S, and also optionally substituted with at least one member selected from the group consisting of —Cl, —Br, —F, —I, —OH, —NH₂ and —SH. A derivative of 2,5-furan dicarboxylic acid can also be prepared by substitution of an ester or halide at the location of one or both of the acid moieties.

Examples of suitable C₂-C₁₂ aliphatic diols include, but are not limited to, ethylene glycol, diethylene glycol, 1,2-propanediol, 1,3-propanediol, 1,4-butanediol, 1,5-pentanediol, 1,6-hexanediol, 1,4-cyclohexanedimethanol, and 2,2-dimethyl-1,3-propanediol.

The polymer may be a copolymer (random or block) derived from furandicarboxylic acid, at least one of a diol or a polyol monomer, and at least one of a polyfunctional aromatic acid or a hydroxyl acid. The molar ratio of furandicarboxylic acid to other diacids can fall within any range, for example the molar ratio of either component can be greater than 1:100 or alternatively in the range of 1:100 to 100 to 1 or 1:9 to 9:1 or 1:3 to 3:1 or 1:1. In general, to attain a desired mole ratio, the diol is added to the reaction mixture in excess, preferably at a level of 1.2 to 3 equivalents based on the total amount of diacids charged.

Examples of other diol and polyol monomers that can be included, in addition to those named above, in the polymerization monomer makeup from which a copolymer can be made include 1,4-benzenedimethanol, poly(ethylene glycol), poly(tetrahydrofuran), glycerol, 2,5-di(hydroxymethyl)tetrahydrofuran, isosorbide, isomannide, pentaerythritol, sorbitol, mannitol, erythritol, and threitol.

Examples of suitable polyfunctional acids include but are not limited to terephthalic acid, isophthalic acid, adipic acid, azelic acid, sebacic acid, dodecanoic acid, 1,4-cyclohexane dicarboxylic acid, maleic acid, succinic acid, and 1,3,5-benzenetricarboxylic acid.

Examples of suitable hydroxy acids include but are not limited to, glycolic acid, hydroxybutyric acid, hydroxycaproic acid, hydroxyvaleric acid, 7-hydroxyheptanoic acid, 8-hydroxycaproic acid, 9-hydroxynonanoic acid, or lactic acid; or those derived from pivalolactone, ε-caprolactone or L,L, D,D or D,L lactides.

Examples of suitable copolymers derived from furandicarboxylic acid, at least one of a diol or a polyol monomer, and at least one of a polyfunctional acid or a hydroxyl acid include, but are not limited to, copolymer of 1,3-propanediol, 2,5-furandicarboxylic acid and terephthalic acid; copolymer of 1,3-propanediol, 2,5-furandicarboxylic acid and succinic acid; copolymer of 1,3-propanediol, 2,5-furandicarboxylic acid; copolymer of 1,3-propanediol, 2,5-furandicarboxylic acid and adipic acid; copolymer of 1,3-propanediol, 2,5-furandicarboxylic acid and sebacic acid, copolymer of 1,3-propanediol, 2,5-furandicarboxylic acid and isosorbide; copolymer of 1,3-propanediol, 2,5-furandicarboxylic acid and isomannide.

Additional details regarding the preparation of PTF homopolymers and copolymers can be found in U.S. Patent Application Publication US2014/0205786.

The polymer composition may comprise a polymer blend comprising poly(trimethylene furandicarboxylate) (PTF) and an ethylene polymer or copolymer, wherein the blend comprises 0.1 to 99.9% or 5 to 75% or 10 to 50% by weight of PTF based on the total weight of the polymer blend. Ethylene polymers or copolymers include polyethylenes as described below, or ethylene copolymerized and a polar comonomer such as vinyl acetate, alkyl acrylates, alkyl methacrylates and mixtures thereof, also as described below. Inclusion of such ethylene polymers or copolymers may increase the peelability of seals comprising the PTF composition.

Although not required, conventional additives may be added to the compositions, films or articles of the invention herein. The poly(trimethylene furandicarboxylate) polymer composition may further comprise modifiers and other additives, including without limitation, plasticizers, impact modifiers, stabilizers including viscosity stabilizers and hydrolytic stabilizers, lubricants, antioxidants, oxygen scavengers, UV light stabilizers, antifog agents, antistatic agents, dyes, pigments or other coloring agents, carbon black, fillers, including nanoparticles, nucleating agents, flame retardant agents, reinforcing agents, foaming and blowing agents and processing aids known in the polymer compounding art like for example antiblock agents, extrusion aids, slip agents, and release agents, others known to those of skill in the art, and mixtures thereof. Notably, oxygen scavengers or fillers such as nanoparticles may be included in the PTF composition to augment its oxygen barrier performance. The modifiers and other additives may be present in the poly(trimethylene furandicarboxylate) polymer composition in amounts of up to 20 weight percent, such as from 0.01 to 7 weight percent, or from 0.01 to 5 weight percent, the weight percentage being based on the total weight of the poly(trimethylene furandicarboxylate) polymer composition.

The polymers described herein are of value in all forms of application where currently PET and similar polyesters are used.

The PTF composition should have an appropriate molecular weight to obtain sufficient mechanical properties. Intrinsic viscosity (IV) is determined by measuring the flow time of a solution of known polymer concentration and the flow time of the polymer solvent in a capillary viscometer, as set forth in ASTM D2857.95 at 19° C. The composition has an IV that generally ranges from about 0.4 dl/g to about 2.0 dl/g, such as about 0.4 dl/g to about 0.80 dl/g, or about 0.80 dl/g to about 1.5 dl/g, or at least about 0.90 dl/g, such as about 1.3 to 1.5 dl/g, as measured in a 1:1 by weight solution of dichloromethane and trifluoroacetic acid.

The composition also is preferably clear (though colorants may be added if desired) and exhibits good flavor barrier properties, i.e., low flavor permeation, low flavor scalping and no importation of odors and flavors to the package contents. Significantly, the composition usually is heat-sealable at relatively low temperatures, and has good heat-seal strength and hot-tack strength to support most packaging applications.

The article can be a film, a sheet, or a multi-layer laminate, for example a packaging film, comprising a sealant layer of PTF. Notably, the terms “film” and “sheet” are synonymous and used interchangeably herein. When the article is a film, it can be unoriented or oriented, or uniaxially oriented or biaxially oriented. The article can be a shaped or molded article such as one or more of a container, a container and a lid or a cap, a cap liner or a container and a closure, for example a container such as a molded container or a thermoformed container.

The compositions described herein may be formed into films or other articles. A multilayer film will have two or more layers, wherein the inside surface layer will be a heat-sealable polyester composition comprising PTF as described herein. The film is preferably a multilayer film formed in a coextrusion process combining a PTF layer with other film layers including polyolefins, ethylene copolymers, ionomers, polyamides, polycarbonates, acrylics, polystyrenes, adhesion tie layers, ethylene vinyl alcohol, PVDC, and the like. Because of their low-temperature processability leading to good adhesion, PTF compositions can also be extrusion-coated onto other films or substrates to provide multilayer films. Monolayer films of PTF compositions can be easily laminated to other layers using an adhesion tie layer such as an ethylene vinyl acetate (EVA) or an anhydride modified ethylene methyl acrylate (EMA) copolymer. Such multilayer films expand the possible applications of the PTF compositions in films, since other layers can impart additional desired characteristics such as mechanical strength, toughness, additional barrier properties, heat resistance, or printability, among others. A poly(trimethylene furandicarboxylate) (PTF) composition advantageously forms the multilayer film's sealant layer and also provides gas barrier properties.

The multilayer structure can involve at least three categorical layers including, but not limited to, an external or outside surface layer that serves as a structural or abuse layer, an inner barrier layer, and/or bulking layer, and a sealant layer making contact with and compatible with the intended contents of the package and capable of forming the necessary seals (e.g. most preferably heat-sealable) to itself and the other parts of the package. Other inner layers may also be present to serve as adhesion or “tie” layers to help bond these layers together or delamination layers to provide burst peel properties.

### External Layer

The outside surface layer, or external layer, of the packaging film provides the outside layer of a package and is the layer farthest from the packaged contents. When prepared as a tubular blown film, the outside surface layer may be the outermost layer of the tubular multilayer film, but is not necessarily so.

Any suitable material can be used for the external layer. For example, without limitation, the outside layer may comprise polyester, polyamide (PA), polystyrene (PS), polycarbonate (PC), poly(methyl methacrylate) (PMMA), cyclic olefin copolymer (COC), polypropylene (PP), polyethylene (PE) or combinations thereof, providing for the ability to weld or seal the films by extremely high temperatures without the film being bonded to the welder terminal. As a result, higher cycle numbers, i.e., greater throughput, may be achieved on the sealing machines. In addition, the film is substantially less sensitive to external injury or abuse and possesses excellent optical properties such as gloss and transparency. Furthermore, the film may be particularly well suited for inscribing or printing. The outside structural or abuse layer can be oriented or non-oriented polyester or oriented or non-oriented polypropylene, and can also include oriented or non-oriented polyamide (nylon), polyethylene such as HDPE, paper, or foil. This layer, when optically transparent, may be reverse printable. It should be unaffected (chemically and dimensionally stable) by the sealing temperatures used to make the package, since the package is sealed through the entire thickness of the multilayer structure. When the outer structural or abuse layer is not optically transparent, this layer can be surface printed and then optionally coated with a protective coating or lacquer. The properties of this coating, including its thickness, can control the stiffness of the multilayer film. Suitably, the thickness of the coating may range from about 10 to about 100 μm or from about 12 um to about 50 μm.

For the external layer, polyesters such as polyethylene terephthalate (PET) provide excellent optical properties, such as gloss and transparency, and provide a high speed of further processing (cycle numbers) due to the high temperature resistance. Preferably, the external layer comprises or consists essentially of polyester, notably polyethylene terephthalate (PET). Other suitable polyesters include polytrimethylene terephthalate (PTT), polyethylene naphthalate (PEN), and poly(cyclohexylene dimethylene terephthalate).

Alternatively, the external layer comprises polyamide. Suitable polyamides are generally prepared by polymerization of lactams or amino acids (e.g., nylon 6 or nylon 11), or by condensation of diamines such as hexamethylene diamine with dibasic acids such as succinic, adipic, or sebacic acid. The polyamides may also include copolymerized units of additional comonomers to form terpolymers or higher order polymers. Suitable polyamides include without limitation nylon 6, nylon 9, nylon 10, nylon 11, nylon 12, nylon 6,6, nylon 6,10, nylon 6,12, nylon 6I, nylon 6T, nylon 6.9, nylon 12,12, copolymers thereof and blends of amorphous and semicrystalline polyamides. As used herein, the term “polyamide” also includes polyamide nano-composites such as those available commercially under the tradename AEGIS polyamides from Honeywell International Inc. or IMPERM polyamide (nylon MXD6) from Mitsubishi Gas Chemical Company.

Preferred polyamides include polyepsiloncaprolactam (nylon 6); polyhexamethylene adipamide (nylon 6,6); nylon 11; nylon 12, nylon 12,12 and copolymers and terpolymers such as nylon 6/66; nylon 6,10; nylon 6,12; nylon 6,6/12; nylon 6/6, and nylon 6/6T, or blends thereof. More preferred polyamides are polyepsiloncaprolactam (nylon 6), polyhexamethylene adipamide (nylon 6,6), and nylon 6/66; most preferred is nylon 6. Although these polyamides are preferred polyamides, other polyamides, such as amorphous polyamides, are also suitable for use. Amorphous polyamides include amorphous nylon 6I,6T are available from E.I. du Pont de Nemours and Company (DuPont) under the tradename SELAR® PA or EMS under the tradename of Grivory®. Other suitable amorphous polyamides include those described in U.S. Pat. Nos. 5,053,259; 5,344,679; 5,480,945; 5,408,000; 4,174,358; 3,393,210; 2,512,606; 2,312,966; and 2,241,322.

Alternatively, the external layer comprises polypropylene (PP) or polyethylene (PE). When the external layer comprises PP or PE, it may provide a good barrier to moisture permeating from the exterior of the package.

Polyethylenes are preferably selected from homopolymers and copolymers of ethylene. Various types of polyethylene homopolymers may be used in the external layer; for example, ultra-low density polyethylene (ULDPE), very low density polyethylene (VLDPE), low density polyethylene (LDPE), linear low density polyethylene (LLDPE), high density polyethylene (HDPE), or metallocene polyethylene (mPE). For packaging films, LLDPE is preferred. Unless otherwise specified in limited circumstances, the term “polyethylene” as used herein refers to polyethylene homopolymers and copolymers and to blends comprising polyethylene as the major component with other polymers.

Polyethylene may be made by any available process known in the art including high pressure gas, low pressure gas, solution and slurry processes employing conventional Ziegler-Natta, metallocene, and late transition metal complex catalyst systems.

Preferably, a polyethylene copolymer is an ethylene α-olefin copolymer wherein the ethylene copolymer may be an ethylene α-olefin copolymer which comprises ethylene and an α-olefin of three to twenty carbon atoms such as propylene, butene, hexene and octene, preferably an α-olefin of four to eight carbon atoms, such as butene, hexene and octene.

The density of the ethylene α-olefin copolymers ranges from 0.86 g/cm³ to 0.925 g/cm³, 0.86 g/cm³ to 0.91 g/cm³, 0.86 g/cm³ to 0.9 g/cm³, 0.860g/cm³ to 0.89 g/cm³, 0.860 g/cm³ to 0.88 g/cm³, or 0.88 g/cm³ to 0.905 g/cm³. Resins made by Ziegler-Natta type catalysis and by metallocene or single site catalysis are included provided they fall within the density ranges so described. The metallocene or single site resins useful herein are (i) those which have an I-10/I-2 ratio of less than 5.63 and an Mw/Mn (polydispersity) of greater than (I-10/I-2)−4.63, and (ii) those based which have an I-10/I-2 ratio of equal to or greater than 5.63 and a polydispersity equal to or less than (I-10/I-2)−4.63. Preferably the metallocene resins of group (ii) may have a polydispersity of greater than 1.5 but less than or equal to (I-10/I-2)−4.63. Suitable conditions and catalysts which can produce substantially linear metallocene resins are described in U.S. Pat. No. 5,278,272. The reference gives full descriptions of the measurement of the well-known rheological parameters I-10 and I-2, which are flow values under different loads and hence shear conditions. It also provides details of measurements of the well-known Mw/Mn ratio determination, as determined by gel-permeation chromatography.

Suitable polypropylenes include homopolymers, random copolymers, block copolymers, terpolymers of propylene, or combinations or two or more thereof. Copolymers of propylene include copolymers of propylene with other olefin such as ethylene, 1-butene, 2-butene and the various pentene isomers, and the like, and preferably copolymers of propylene with ethylene, wherein propylene is the major comonomer. Suitable terpolymers of propylene include copolymers of propylene with ethylene and one other olefin. Random copolymers (statistical copolymers) have propylene and the comonomer(s) randomly distributed throughout the polymeric chain in ratios corresponding to the feed ratio of the propylene to the comonomer(s). Block copolymers are made up of chain segments consisting of propylene homopolymer and of chain segments consisting of, for example, random copolymers of propylene and ethylene.

Polypropylene homopolymers or random copolymers can be manufactured by any known process (e.g., using Ziegler-Natta catalyst, based on organometallic compounds or on solids containing titanium trichloride). Block copolymers can be manufactured similarly, except that propylene is generally first polymerized by itself in a first stage and propylene and additional comonomers such as ethylene are then polymerized, in a second stage, in the presence of the polymer obtained during the first.

In another embodiment, the external layer may be metallic. Examples of suitable materials for the metallic layer or substrate include, but are not limited to, stainless steel, carbon steel, and aluminum. The metallic external layer may alternatively comprise metallized polymers such as metallized PP or PET. In such embodiments, the polymer comprises PTF or a blend of PTF and poly(alkylene furandicarboxylate) or a blend of PTF and poly(alkylene terephthalate) such as PET or a copolymer comprising PTF repeat units that is coated on a substrate that is typically a metal comprising but not limited to aluminum, stainless steel or carbon steel, or coated onto the metallic side of a metallized film, to provide a sealant layer for adhering the metallic external layer to a polymeric material to form a packaging article. In this embodiment, the thickness of the coated polymer useful as a sealant layer is in the range of 1-100 microns, 2-50 microns or 5-50 microns.

### Inner Layer(s)

Inner layers can include one or more barrier layers, depending on which atmospheric conditions (oxygen, humidity, light, and the like) that potentially can affect the product inside the package. Barrier layers can be, for example, metallized PP or PET, polyethylene vinyl alcohol (EVOH), polyvinyl alcohol, polyvinylidene chloride, polyolefins, cyclic olefin copolymers, polyvinyl acetate, or blends thereof with polyethylene, polyvinyl alcohol, or polyamide, aluminum foil, nylon, blends or composites of the same as well as related copolymers thereof. Barrier layer thickness may depend on factors such as the sensitivity of the product and the desired shelf life.

The term “gas barrier layer” as used herein denotes a film layer that allows transmission through the film of less than 1000 cc of gas, such as oxygen, per square meter of film per 24-hour period at 1 atmosphere and at a temperature of 23° C. (73° F.) at 50% relative humidity. Preferably, the barrier layer provides for oxygen transmission below 500, below 100, below 50, below 30 or below 15 cc/m²-day for the multilayer films. When factored for thickness the films preferably have oxygen permeation levels of less than 40 or less than 30 cc-mil/m²-day. Other polymers may be present as additional components in the barrier layer so long as they do not raise the permeability of the barrier layer above the limit defined above.

The gas barrier layer of the multilayer films preferably comprises ethylene vinyl alcohol polymers and mixtures thereof. Unless otherwise specified in limited circumstances, the term “EVOH” as used herein refers to both ethylene vinyl alcohol polymers and blends of ethylene vinyl alcohol polymers with other polymers.

EVOH polymers generally have content of copolymerized residues of ethylene between about 15 mole % to about 60 mole %, more preferably between about 20 to about 50 mole %. The density of commercially available EVOH generally ranges from between about 1.12 g/cm³ to about 1.20 gm/cm³, the polymers having a melting temperature ranging from between about 142° C. and 191° C. EVOH polymers can be prepared by well-known techniques or can be obtained from commercial sources. EVOH copolymers may be prepared by saponifying or hydrolyzing ethylene vinyl acetate copolymers. Thus, EVOH may also be known as hydrolyzed ethylene vinyl acetate (HEVA) copolymer. The degree of hydrolysis is preferably from about 50 to 100 mol %, more preferably from about 85 to 100 mol %. In addition, the weight average molecular weight, Mw, of the EVOH component useful in the articles described herein, calculated from the degree of polymerization and the molecular weight of the repeating unit, may be within the range of about 5,000 Daltons to about 300,000 Daltons, with about 60,000 Daltons being more preferred.

Suitable EVOH polymers may be obtained from Eval Company of America or Kuraray Company of Japan under the tradename EVAL™. EVOH is also available under the tradename SOARNOL™ from Noltex L.L.C. Examples of such EVOH resins include EVAL™ grades F101, E105, J102, and SOARNOL™ grades DT2903, DC3203 and ET3803. Preferably, the EVOH used in the invention is orientable with a stretch ratio of from about 3×3 to about 10×10 without loss in barrier properties from pinholing, necking or breaks in the EVOH layer.

Of special note are EVOH resins sold under the tradename EVAL™ SP obtained from Eval Company of America or Kuraray Company of Japan that may be useful as components in the films described herein. EVAL™ SP is a type of EVOH that exhibits enhanced plasticity and that is suited for use in packaging applications including shrink film, polyethylene terephthalate (PET)-type barrier bottles and deep-draw cups and trays. Examples of such EVOH resins include EVAL™ SP grades 521, 292 and 482. The EVAL SP grades of EVOH are easier to orient than the conventional EVAL resins. These EVOH polymers are a preferred class for use in the multilayer film compositions described herein. Without being bound to theory, it is believed that the enhanced orientability of these resins derives from their chemical structure, in particular the level of head to head adjacent hydroxyl groups, i.e., 1,2-glycol structural units, in the EVOH polymer chain.

It has been found that EVOH polymers having a relatively high level of 1,2-glycol units in the EVOH polymer chain are particularly suited for use in the multilayer film. For example, about 2 to about 8 mol % of 1,2-glycol structural units, preferably about 2.8 to about 5.2 mol % of 1,2-glycol units may be present in the EVOH polymer chain.

Such polymers can be produced by increasing the amount of adjacent copolymerized units of vinyl acetate produced during polymerization of ethylene and vinyl acetate above the level generally used. When such polymers are hydrolyzed to form EVOH, an increased amount of head-to-head vinyl alcohol adjacency, that is, an increased amount of the 1,2-glycol structure result. It has been reported in the case of polyvinyl alcohol that the presence of the 1,2-glycol structure in polyvinyl alcohol can influence the degree of crystallinity obtained in these alcohols and thereby the tensile strength. See, for example F. L. Marten & C. W. Zvanut, Chapter 2 Manufacture of Polyvinyl Acetate for Polyvinyl Alcohol, Polyvinyl Alcohol Developments (C. A. Finch, ed.) John Wiley, New York 1992.

The more orientable grades of EVOH will generally have lower yield strength, lower tensile strength and lower rates of strain hardening than other EVOH polymers of equivalent ethylene content, as measured by mol % ethylene.

The EVOH composition may optionally be modified by including additional polymeric materials selected from the group consisting of polyamides, including amorphous polyamides such as MXD6, polyvinyl acetate (PVA), ionomers, and ethylene polymers and mixtures thereof. These modifying polymers may be present in amounts up to 30 weight % of the EVOH composition.

However, the oxygen barrier effectiveness of EVOH can be reduced by the presence of moisture. Therefore, it is desirable to protect the EVOH layer from moisture from the product contained within the package or from outside the package. Notably, the gas barrier layer is positioned in the multilayer film so that at least 60%, preferably at least 65%, of the total film thickness is to the inside of the gas barrier layer.

In a preferred embodiment, the coextruded multilayer structure may comprise a layer of EVOH sandwiched between two layers of polyamide, one on each side of the EVOH layer. This leads to a very efficient oxygen barrier and at the same time ensures excellent embedding and stabilization of the EVOH layer between the two polyamide layers as carrier layers.

The inner layer can include one or more bulking layers. This layer is usually added to create a structure that has a final, predefined thickness by using a common polymer that is of low cost. Bulking layers can be, for example, polyolefin, polyolefin polar copolymer, polyester and or blends of various bulking layer components. Polyolefin polar copolymers include copolymers of ethylene with polar comonomers including vinyl esters such as vinyl acetate, or C₃-C₅ alpha,beta unsaturated carboxylic acid esters such as C₁-C₈, preferably C₁-C_{4,} alkyl esters of acrylic acid or methacrylic acid such as methyl acrylate, ethyl acrylate or n-butyl acrylate. The ethylene copolymers can also include copolymers of ethylene and C₃-C₅ alpha,beta unsaturated carboxylic acid such as acrylic acid or methacrylic acid and ionomers thereof, wherein a portion of the carboxylic acid moieties are neutralized to provide carboxylate salts comprising alkali metal cations, alkaline earth cations, or transition metal cations, such as sodium, magnesium, calcium and/or zinc cations. The acid copolymers and ionomers may also comprise additional comonomers such as C₃-C₅ alpha,beta unsaturated carboxylic acid esters described above.

A bulking layer is also suitable for incorporation of regrind and scrap generated in the manufacturing process. For example, scrap generated from material that, for one reason or another, is not suitable for sale, or material that is generated by trimming the edges off a semi-finished roll, can be ground up and incorporated into the inner layer providing bulk at relatively low cost.

### Structure Layer

A structure layer, which can be an external layer and/or inner layer(s), and barrier layer can be combined to comprise several layers of polymers that provide effective barriers to moisture and oxygen and bulk mechanical properties suitable for processing and/or packaging the product, such as clarity, toughness and puncture-resistance. In some applications, the functions of structure and barrier layers may be combined in a single layer of a suitable resin. For example, nylon, polyethylene, polypropylene or PET may be suitable for both structure and barrier functions.

### Adhesion Layers

Inner layers can include one or more adhesion layers. This adhesion layer is usually designed to adhere the outside structural layer to an inner layer, an inner layer to the sealant layer or, in the case where the inner layer may only be acting as an adhesion layer, bonding the outside layer directly to the sealant layer. Adhesion layers may also bond other inner layers to each other.

The coextruded multilayer structure may comprise one or more additional layers to serve as adhesion layers between functional layers to improve interlayer adhesion and prevent delamination of the layers. For example, such adhesion layers may be positioned between the external layer and the sealant layer.

The adhesion layer(s) are compositionally distinct from the external layer and from the heat sealant layer. The term “compositionally distinct” as used herein refers to one or more parameters that are not identical in the heat seal layer and the adhesion layer. The parameters include, for example, the number of components, the ratio of components or their chemical structure, in particular, the monomer ratio of polymeric components having the same monomers.

Suitable adhesion compositions described in U.S. Pat. Nos. 6,545,091, 5,217,812, 5,053,457, 6,166,142, 6,210,765 and U.S. Patent Application Publication 2007/0172614. Preferred adhesion compositions useful in the multilayer film include a multicomponent composition comprising (1) a functionalized polymer, (2) an ethylene polymer or copolymer or propylene polymer or copolymer, and/or optionally (3) a tackifier. These adhesion compositions are particularly suitable for use as an adhesion or “tie” layer in multilayer films. The adhesion compositions provide suitable adhesion between the various layers of the film and provide improved adhesion in biaxially oriented films.

The functionalized polymers useful as component (1) of an adhesion composition comprise anhydride-modified polymers and copolymers comprising copolymerized units of ethylene and a comonomer selected from the group consisting of C₄-C₈ unsaturated acids having at least two carboxylic acid groups, and cyclic anhydrides, monoesters and diesters of such acids. Mixtures of these components are also useful. The ethylene polymers or copolymers useful as component (2) of the adhesion composition comprise at least one ethylene polymer or copolymer chemically distinct from the functionalized polymer that is the component (1) polymer. The term “chemically distinct” as used herein refers to one or more parameters that are not identical between the polymers of components (1) and (2), for example a) the ethylene copolymer of the second component of the adhesion comprises at least one species of copolymerized monomer that is not present as a comonomer in the functionalized polymer component;b) the functionalized polymer component of the adhesion comprises at least one species of copolymerized monomer that is not present in the ethylene copolymer of the second component of the adhesion; or c) the ethylene copolymer that is the second component of the adhesion is not an anhydride-grafted or functionalized ethylene copolymer as defined above. Thus, the first and second polymers are different in chemical structure and are distinct polymer species.

The functionalized polymer may be a modified copolymer, meaning that the polymer is grafted and/or copolymerized with organic functionalities. Modified polymers for use in the tie layer may be modified with acid, anhydride and/or epoxide functionalities. Examples of the acids and anhydrides used to modify polymers, which may be mono-, di- or polycarboxylic acids are acrylic acid, methacrylic acid, maleic acid, maleic acid monoethylester, fumaric acid, fumaric acid, itaconic acid, crotonic acid, itaconic anhydride, maleic anhydride and substituted maleic anhydride, e.g. dimethyl maleic anhydride or citrotonic anhydride, nadic anhydride, nadic methyl anhydride, and tetrahydrophthalic anhydride, or combinations of two or more thereof, maleic anhydride being preferred.

In the case where the one or more olefin homopolymers and/or copolymers are acid-modified, they may contain of from 0.05 to 25 weight % of residues of copolymerized or grafted acid(s), the weight percentage being based on the total weight of the modified polymer.

Modified polymers that are suitable for use as functionalized polymer components of the preferred adhesion composition include anhydride-grafted homopolymers or copolymers.

When anhydride-modified polymer is used, it may contain from 0.03 to 10 wt %, 0.05 to 5 wt %, or 0.05 to 3 wt % of an anhydride, the weight percentage being based on the total weight of the modified polymer. These include polymers that have been grafted with from 0.1 to 10 weight % of an unsaturated dicarboxylic acid anhydride, preferably maleic anhydride. Generally, they will be grafted olefin polymers, for example grafted polyethylene, grafted EVA copolymers, grafted ethylene alkyl acrylate copolymers and grafted ethylene alkyl methacrylate copolymers, each grafted with from 0.1 to 10 weight % of an unsaturated dicarboxylic acid anhydride. Specific examples of suitable anhydride-modified polymers are disclosed in U.S. Patent Application Publication 2007/0172614.

The functionalized polymer may also be an ethylene copolymer comprising copolymerized units of ethylene and a comonomer selected from the group consisting of C₄-C₈ unsaturated anhydrides, monoesters of C₄-C₈ unsaturated acids having at least two carboxylic acid groups, diesters of C₄-C₈ unsaturated acids having at least two carboxylic acid groups and mixtures of such copolymers. The ethylene copolymer may comprise from about 3 to about 25 weight % of copolymerized units of the comonomer. The copolymer may be a dipolymer or a higher order copolymer, such as a terpolymer or tetrapolymer. The copolymers are preferably random copolymers. Examples of suitable comonomers of the ethylene copolymer include unsaturated anhydrides such as maleic anhydride and itaconic anhydride; C₁-C₂₀ alkyl monoesters of butenedioic acids (e.g. maleic acid, fumaric acid, itaconic acid and citraconic acid), including methyl hydrogen maleate, ethyl hydrogen maleate, propyl hydrogen fumarate, and 2-ethylhexyl hydrogen fumarate; C₁-C₂₀ alkyl diesters of butenedioic acids such as dimethylmaleate, diethylmaleate, and dibutylcitraconate, dioctylmaleate, and di-2-ethylhexylfumarate. These functionalized polymer components of the adhesion composition are ethylene copolymers obtained by a process of high-pressure free radical random copolymerization, rather than graft copolymers. The monomer units are incorporated into the polymer backbone or chain and are not incorporated to an appreciable extent as pendant groups onto a previously formed polymer backbone.

Examples of epoxides used to modify polymers are unsaturated epoxides comprising from four to eleven carbon atoms, such as glycidyl (meth)acrylate, allyl glycidyl ether, vinyl glycidyl ether and glycidyl itaconate, glycidyl (meth)acrylates being particularly preferred.

Epoxide-modified ethylene copolymers preferably contain from 0.03 to 15 weight %, 0.03 to 10 weight %, 0.05 to 5 weight %, or 0.05 to 3% of an epoxide, the weight percentage being based on the total weight of the modified ethylene copolymer. Preferably, epoxides used to modify ethylene copolymers are glycidyl (meth)acrylates. The ethylene/glycidyl (meth)acrylate copolymer may further contain copolymerized units of an alkyl (meth)acrylate having from one to six carbon atoms Representative alkyl (meth)acrylates include methyl (meth)acrylate, ethyl (meth)acrylate, propyl (meth)acrylate, butyl (meth)acrylate, isobutyl (meth)acrylate, hexyl (meth)acrylate, or combinations of two or more thereof. Of note are ethyl acrylate and butyl acrylate. Preferably, modified ethylene copolymers comprised in the tie layer are modified with acid, anhydride and/or glycidyl (meth)acrylate functionalities.

The ethylene copolymers suitable for use in adhesion layers of the coextruded multilayer film structure can be produced by any means known to one skilled in the art using either autoclave or tubular reactors (e.g. U.S. Pat. Nos. 3,404,134, 5,028,674, 6,500,888, 3,350,372, and 3,756,996).

Preferably, each adhesion layer independently comprises a functionalized polymer comprising grafted polyethylene, grafted EVA copolymers, grafted ethylene alkyl acrylate copolymers or grafted ethylene alkyl methacrylate copolymers, each grafted with from 0.1 to 10 weight % of an unsaturated dicarboxylic acid anhydride; or copolymers comprising copolymerized units of ethylene and a comonomer selected from the group consisting of C₄-C₈ unsaturated acids having at least two carboxylic acid groups, and cyclic anhydrides, monoesters and diesters of such acids.

Compositions comprising olefin polymers and modified polymers thereof are commercially available under the trademarks APPEEL®, BYNEL®, ELVALOY®AC, ELVALOY® and ELVAX® from DuPont.

A second component of a preferred adhesion composition comprises at least one ethylene polymer or copolymer or propylene polymer or copolymer compositionally distinct from the first functionalized polymer component. Ethylene polymers or copolymers used as a component of the adhesion composition may be polyethylene homopolymers, copolymers of ethylene and alpha-olefins, including copolymers with propylene and other alpha-olefins. Ethylene polymers or copolymers suitable for use as the second component include high density polyethylenes, low density polyethylenes, very low density polyethylenes (VLDPE), linear low density polyethylenes, and copolymers of ethylene and alpha-olefin monomers prepared in the presence of metallocene catalysts, single site catalysts and constrained geometry catalysts (hereinafter referred to as metallocene polyethylenes, or MPE). Suitable ethylene copolymers and methods for their preparation are disclosed in U.S. Patent Application Publication 2007/0172614. Propylene polymers or copolymers include those described above. The ethylene copolymer used as the second component of the adhesion composition may also comprise copolymerized units of ethylene and a polar comonomer such as vinyl acetate, alkyl acrylates, alkyl methacrylates and mixtures thereof. The alkyl groups will have from 1 to 10 carbon atoms. Additional comonomers may be incorporated as copolymerized units in the ethylene copolymer. Suitable copolymerizable monomers include carbon monoxide, methacrylic acid and acrylic acid. Ethylene alkyl acrylate carbon monoxide terpolymers are examples of such compositions, including ethylene n-butyl acrylate carbon monoxide terpolymers.

The ethylene copolymer of the second component may also be an ethylene alkyl acrylate or ethylene alkyl methacrylate copolymer. Alkyl acrylates and alkyl methacrylates may have alkyl groups of 1 to 10 carbon atoms, for example methyl, ethyl or butyl groups. The relative amount of the alkyl acrylate or alkyl methacrylate comonomer units in the copolymers can vary broadly from a few weight % to as much as 45 weight %, based on the weight of the copolymer. Mixtures of ethylene alkyl acrylate and/or alkyl methacrylate copolymers may also be used.

The adhesion composition may also include a tackifier. The presence of tackifier facilitates bond adhesion when the film is oriented and later shrunk. The tackifier may be any suitable tackifier known generally in the art. For example, the tackifier may include types listed in U.S. Pat. No. 3,484,405. Suitable tackifiers include a variety of natural and synthetic resins and rosin materials. Tackifier resins that can be employed are liquid, semi-solid to solid, complex amorphous materials generally in the form of mixtures of organic compounds having no definite melting point and no tendency to crystallize. These include coumarone-indene resins, such as the para-coumarone-indene resins, terpene resins, including styrenated terpenes, butadiene-styrene resins having molecular weights ranging from about 500 to about 5,000, polybutadiene resins having molecular weights ranging from about 500 to about 5,000, hydrocarbon resins produced by catalytic polymerization of fractions obtained in the refining of petroleum, having a molecular weight range of about 500 to about 5,000, polybutenes obtained from the polymerization of isobutylene, hydrogenated hydrocarbon resins, rosin materials, low molecular weight styrene hard resins or disproportionated pentaerythritol esters, aromatic tackifiers, including thermoplastic hydrocarbon resins derived from styrene, alpha-methylstyrene, and/or vinyltoluene, and polymers, copolymers and terpolymers thereof, terpenes, terpene phenolics, modified terpenes, and combinations thereof. These latter materials may be further hydrogenated in part or in entirety to produce alicyclic tackifiers. A more comprehensive listing of tackifiers that are suitable for use herein is provided in TAPPI CA Report #55, Technical Association of the Pulp and Paper Industry, 1975, pp 13-20, which lists over 200 commercially available tackifier resins.

The thickness of each adhesion layer of the multilayer structure may be independently between 1 and 100 5 and 50 or 5 to 30 μm or 2 to 10

### Delamination Layer

Compositions described herein as useful in adhesion layers may also be useful in delamination layers, depending on the layers that are adjacent to them.

The function of an inner delamination layer is to provide delamination between the sealant portion of the film and the mechanical support and optional barrier portions of the film. The adhesion between the delamination layer and the layer it contacts toward the outside of the package should be selected so that it provides sufficient adhesion to prevent delamination between the film layers during processing, package (such as a pouch) formation and package filling, yet low enough to provide easy peel propagation when the package is opened by the consumer to access the contents of the package.

Desirably, the adhesion between the polyamide layer and the delamination layer of the film is from 0.1 to 10 N/15 mm, preferably from 2 to 8 N/15 mm, or from 2 to 8 N/15 mm, before heat sealing to prepare and/or seal the package. In some instances, the adhesion between the polyamide layer and the delamination layer may increase when heat is applied to the film, such as during heat sealing. The increase in adhesion may be temperature dependent, with higher sealing temperatures leading to higher adhesion. For example, heat sealing below 160° C. may provide adhesion below 8 N/15 mm. These properties provide a robust seal during transport and storage, while also providing an easily propagated seal opening. At sealing temperatures above 160° C., the adhesion may be up to 15 N/15 mm. This allows for preparing strong seals at portions of the package that are not intended to be opened, while providing easy opening for portions of the package that are intended to be opened.

The adhesion between the delamination layer and the adjacent layer toward the inside of the package is desirably greater than 10 N/15 mm, so that the package retains necessary integrity under shipping and storage conditions, and delamination when desired reliably occurs between the delamination layer and the adjacent layer toward the outside of the package.

The delamination layer may comprise or consist essentially of an anhydride-modified polymer comprising a base polymer comprising a polyethylene homopolymer or copolymer, polypropylene homopolymer or copolymer, or an ethylene copolymer comprising copolymerized units derived from ethylene and at least one additional polar comonomer, preferably ethylene vinyl acetate copolymer, ethylene alkyl (meth)acrylate copolymer, wherein the base polymer is grafted with up to 1 weight % of an unsaturated dicarboxylic acid anhydride, preferably maleic anhydride; or an acid copolymer or ionomer thereof.

A composition particularly useful as a delamination layer adjacent to and in direct contact with a polyamide structure layer comprises a blend adhesive composition comprising an ethylene methacrylate copolymer, very low density polyethylene and anhydride modified ethylene alkyl acrylate copolymers with density of 0.93 g/cm³, MI of 1.6 g/10 min, m.p. of 92° C., available commercially as Bynel® 21E787 from DuPont.

Additional details of such delamination layer compositions are disclosed in U.S. Patent Application Ser. No. 62/094,145 and the corresponding Intl. Patent Appln. Publn. No. WO2016/100277.

### Articles

The article comprising a sealant layer comprising PTF can be a film, a sheet, a coating, a shaped or molded article, or a layer in a multilayer laminate, for example a lidding film. As used herein, the term “film” can refer to a continuous, planar structure that is oriented or not oriented, or uniaxially oriented or biaxially oriented. In an embodiment, the article in the form of a film, a sheet, a coating, a multi-layer laminate is characterized by an oxygen permeability rate that is at least 2-99% or 50-98% or 75-96% lower than the oxygen permeability rate of PET. In another embodiment, the article in the form of a film, a sheet, a coating, a multi-layer laminate has a carbon dioxide permeability rate that is at least 11-99% or 50-98% or 75-96% lower than the oxygen permeability rate of PET. In another embodiment, the article in the form of a film, a sheet, a coating, a multi-layer laminate has water vapor permeability rate that is at least 3-99% or 25-75% lower than the oxygen permeability rate of a corresponding article comprising PET.

Embodiments of a multilayer structure useful in the article of the invention comprise the following layer structure positioned in order from the outside to the inside:

an outside surface layer comprising polyester, polyamide, polystyrene, polycarbonate, poly(methyl methacrylate), cyclic olefin copolymer, polypropylene, high density polyethylene, or combinations thereof;

an optional layer comprising a first adhesion layer;

an optional gas barrier layer comprising ethylene vinyl alcohol copolymer, cyclic olefin copolymers, polyvinyl acetate, or blends thereof with polyethylene, polyvinyl alcohol, or polyamide,

an optional layer comprising a second adhesion layer;

an optional bulking layer comprising polyethylene homopolymer or copolymer, polypropylene homopolymer or copolymer, or an ethylene copolymer comprising copolymerized units derived from ethylene and at least one additional polar comonomer;

an optional layer comprising a third adhesion layer; and

an inside surface layer the PTF composition.

Notable multilayer structures include those comprising the following layer structure from the outside to the inside:

an outside surface layer comprising polyester;

a layer comprising a first adhesion layer;

a gas barrier layer comprising ethylene vinyl alcohol copolymer sandwiched between two layers of polyamide;

a layer comprising a second adhesion layer;

a bulking layer;

an optional layer comprising a third adhesion layer; and

an inside surface layer comprising the PTF sealant composition.

Another embodiment of a multilayer structure useful in the article of the invention comprises

an outside surface layer comprising polyester, polyamide, polystyrene, polycarbonate, poly(methyl methacrylate), cyclic olefin copolymer, polypropylene, high density polyethylene, or combinations thereof, preferably polyester such as polyethylene terephthalate;

a polyamide layer in direct contact with the delamination layer;

a delamination layer in direct contact with the polyamide layer comprising an anhydride-modified polymer comprising a base polymer comprising a polyethylene homopolymer or copolymer, polypropylene homopolymer or copolymer, or an ethylene copolymer comprising copolymerized units derived from ethylene and at least one additional polar comonomer, preferably ethylene vinyl acetate copolymer, ethylene alkyl (meth)acrylate copolymer, wherein the base polymer is grafted with up to 1 weight % of an unsaturated dicarboxylic acid anhydride, preferably maleic anhydride; or an acid copolymer or ionomer thereof; wherein the adhesion between the polyamide layer and the delamination layer is from 0.1 to 10 N/15 mm, preferably from 2 to 8 N/15 mm; and

an inside surface sealant layer comprising layer comprising the polytrimethylene furandicarboxylate polymer composition.

Notable multilayer structures include those wherein the outside surface layer comprises polyethylene terephthalate polyester, polyamide, polyethylene or polypropylene, preferably polyethylene terephthalate polyester.

Notable multilayer structures include those wherein the gas barrier layer comprises ethylene vinyl alcohol polymer or ethylene vinyl alcohol polymer sandwiched between two layers of polyamide, including those wherein the gas barrier layer is positioned so that at least 60% of the total film thickness is to the inside of the gas barrier layer with respect to a package prepared from the film.

Notable multilayer structures include those wherein the polyamide comprises nylon 6, nylon 9, nylon 10, nylon 11, nylon 12, nylon 6,6, nylon 6,10, nylon 6,12, nylon 61, nylon 6T, nylon 6.9, nylon 12,12, MXD6, nylon 6I,6T, copolymers thereof or blends of amorphous and semicrystalline polyamides; preferably wherein the polyamide comprises nylon 6, nylon 6,6 or nylon 6/66.

Notable multilayer structures include those wherein the bulking layer comprises polyethylene homopolymer or copolymer.

Notable multilayer structures include those wherein the bulking layer comprises an ethylene copolymer comprising copolymerized units derived from ethylene and at least one additional polar comonomer; preferably wherein the ethylene copolymer comprises ethylene vinyl acetate copolymer, ethylene alkyl (meth)acrylate copolymer, ethylene alkyl (meth)acrylic acid copolymer or ionomer thereof, or combination of two or more thereof; and more preferably wherein the ethylene copolymer comprises an ionomer.

Notable multilayer structures include those wherein each adhesion layer independently comprises a functionalized polymer comprising grafted polyethylene, grafted EVA copolymers, grafted ethylene alkyl acrylate copolymers or grafted ethylene alkyl methacrylate copolymers, each grafted with from 0.1 to 10 weight % of an unsaturated dicarboxylic acid anhydride; or copolymers comprising copolymerized units of ethylene and a comonomer selected from the group consisting of C₄-C₈ unsaturated acids having at least two carboxylic acid groups, and cyclic anhydrides, monoesters and diesters of such acids; optionally wherein each adhesion layer independently additionally comprises at least one ethylene polymer or copolymer, chemically distinct from the functionalized polymer, and optionally a tackifier.

Notable embodiments include:

The multilayer structure wherein the outside surface layer comprises polyethylene terephthalate polyester.

The multilayer structure wherein the outside surface layer comprises polyamide.

The multilayer structure wherein the outside surface layer comprises polyethylene or polypropylene.

The multilayer structure wherein the gas barrier layer comprises ethylene vinyl alcohol polymer.

The multilayer structure wherein the gas barrier layer comprises ethylene vinyl alcohol polymer sandwiched between two layers of polyamide.

The multilayer structure wherein the polyamide comprises nylon 6, nylon 9, nylon 10, nylon 11, nylon 12, nylon 6,6, nylon 6,10, nylon 6,12, nylon 6I, nylon 6T, nylon 6.9, nylon 12,12, MXD6, nylon 6I,6T, copolymers thereof or blends of amorphous and semicrystalline polyamides.

The multilayer structure wherein the polyamide comprises nylon 6, nylon 6,6 or nylon 6/66.

The multilayer structure wherein the bulking layer comprises polyethylene homopolymer or copolymer.

The multilayer structure wherein the bulking layer comprises an ethylene copolymer comprising copolymerized units derived from ethylene and at least one additional polar comonomer.

The multilayer structure wherein the ethylene copolymer comprises ethylene vinyl acetate copolymer, ethylene alkyl (meth)acrylate copolymer, ethylene alkyl (meth)acrylic acid copolymer or ionomer thereof, or combination of two or more thereof.

The multilayer structure wherein the ethylene copolymer comprises an ionomer.

The multilayer structure wherein each adhesion layer independently comprises a functionalized polymer comprising grafted polyethylene, grafted EVA copolymers, grafted ethylene alkyl acrylate copolymers or grafted ethylene alkyl methacrylate copolymers, each grafted with from 0.1 to 10 weight % of an unsaturated dicarboxylic acid anhydride; or copolymers comprising copolymerized units of ethylene and a comonomer selected from the group consisting of C₄-C₈ unsaturated acids having at least two carboxylic acid groups, and cyclic anhydrides, monoesters and diesters of such acids.

The multilayer structure wherein each adhesion layer independently additionally comprises at least one ethylene polymer or copolymer, chemically distinct from the functionalized polymer, and optionally a tackifier.

The multilayer structure comprising the following layer structure from the outside to the inside:

an outside surface layer comprising polyester;

a layer comprising a first adhesion layer;

a gas barrier layer comprising ethylene vinyl alcohol copolymer sandwiched between two layers of polyamide;

a layer comprising a second adhesion layer;

an optionally shrinkable forming layer comprising an ionomer;

an optional layer comprising a third adhesion layer; and

an inside surface layer comprising a polyethylene homopolymer or copolymer, or an ethylene alkyl (meth)acrylic acid copolymer or ionomer thereof.

The multilayer structure wherein the inside surface layer comprises an ionomer and the third adhesion layer is not present.

The multilayer structure wherein the inside surface layer comprises a polyethylene homopolymer or copolymer and the third adhesion layer is present.

The multilayer structure having the shape of a sheet or a tube which is produced by a blown film coextrusion process and biaxially oriented by the triple-bubble process.

The multilayer structure having the shape of a sheet which is produced by a cast film coextrusion process and biaxially oriented by tenter frame orientation.

The multilayer structure characterized in that the multilayer structure is fashioned as a food packaging having the form of a shrink bag, a sealable film, or a wrapping film.

Representative examples of multilayer films and laminates include those described below. In these structures, outside to inside layers of the multilayer structure as intended to be used in a package are listed in order from left to right. In the multilayer film structures the symbol “/” represents a boundary between layers. The symbol “//” represents a boundary between a film layer and a nonpolymeric substrate. “PTF” represents a PTF polymer or copolymer or a blend of PTF homopolymer or copolymer with other polymers. The term “ink” is used to designate a printed layer. Where a coextrudable adhesion layer is present, that layer is designated as “tie.” Tie layer compositions in a structure may be the same or different, depending on the compositions of adjacent layers. Delamination layers as described above are designated “Del”. The structures below are not meant to be an exhaustive list of the structures of the invention and are for purposes of example. Those skilled in the art will recognize that other structures will fall within the scope of the invention. Such structures may include one or more adhesion layers, comprising any adhesion composition, including the above-described preferred adhesion compositions. Each embodiment will have particular advantages depending on the particular application.

| | |
|---|---|
| PET/PTF | PE/tie/EVOH/EVA/PTF |
| PET/ink/PET/PTF | PP/ink/PP/tie/PTF |
| PE/tie/PTF | PP/tie/PTF |
| PP/tie/EVOH/EVA/PTF | PE/tie/PET/tie/EVOH/tie/PTF |
| PET/tie/EVOH/EVA/PTF | PET/tie/PE/EVA/PTF |
| PA/EVOH/EVA/PTF | PET/tie/PA/EVOH/PA/tie/ionomer/tie/PTF |
| PET/tie/PA/EVOH/PA/tie/EVA/PTF | PET/tie/PA/EVOH/PA/tie/PTF |
| PA/EVOH/PA/tie/PTF | PA/EVOH/PA/tie/ionomer/tie/PTF |
| PA/EVOH/PA/tie/PP/tie/PTF | PP/tie/PA/EVOH/PA/tie/ionomer or PP/tie/PTF |
| PE/tie/PA/EVOH/PA/tie/ionomer/tie/PTF | PP/tie/PA/EVOH/PA/tie/ionomer/tie/PTF |
| PE/tie/ionomer/tie/PA/EVOH/PA/tie/PTF | PP/tie/PA/EVOH/PA/tie/PTF |
| PE/tie/PA/EVOH/PA/tie/EVA/tie/PTF | PE/tie/PA/EVOH/PA/tie/PP/tie/PTF |
| PP/tie/PA/EVOH/PA/tie/PE/tie/PTF | PE/tie/PA/EVOH/PA/tie/PE/tie/PTF |
| PE/tie/PA/EVOH/PA/tie/PTF | PE/tie/PA/EVOH/PA/tie/PE or PP/tie/PTF |
| PE/tie/PA/EVOH/PA/tie/EMA/tie/PTF | PE/tie/ionomer/tie/EVOH/tie/PTF |
| PET/Tie/PP/ionomer/PA/EVOH/PA/Del/PTF | PET/Tie/PE/ionomer/PA/EVOH/PA/Del/PTF |
| PET/Tie/EVA/ionomer/PA/EVOH/PA/Del/PTF | PET/Tie/EMA/ionomer/PA/EVOH/PA/Del/PTF |
| PET/Tie/PP/PA/EVOH/PA/Del/PTF | PET/Tie/PE/PA/EVOH/PA/Del/PO/PTF |
| PET/Tie/ionomer/PA/EVOH/PA/Del/PTF | PET/Tie/EVA/Tie/PA/EVOH/PA/Del/PO/PTF |
| PET/Tie/EMA/Tie/PA/EVOH/PA/Del/PTF | PA/Tie/PP/ionomer/PA/EVOH/PA/Del/PTF |
| PA/Tie/PE/ionomer/PA/EVOH/PA/Del/PTF | PA/Tie/EVA/ionomer/PA/EVOH/PA/Del/PTF |
| PA/Tie/EMA/ionomer/PA/EVOH/PA/Del/PTF | PA/Tie/PP/PA/EVOH/PA/Del/PO/PTF |
| PA/Tie/PE/PA/EVOH/PA/Del/PTF | PA/Tie/ionomer/PA/EVOH/PA/Del/PO/PTF |
| PA/Tie/EVA/Tie/PA/EVOH/PA/Del/PTF | PA/Tie/EMA/Tie/PA/EVOH/PA/Del/PO/PTF |
| PET/Tie/PP/ionomer/PA/EVOH/PA/Del/PTF | PET/Tie/PE/ionomer/PA/EVOH/PA/Del/PTF |
| PET/Tie/EVA/ionomer/PA/EVOH/PA/Del/PTF | PET/Tie/EMA/ionomer/PA/EVOH/PA/Del/PTF |
| PET/Tie/PP/PA/EVOH/PA/Del/PTF | PET/Tie/PE/PA/EVOH/PA/Del/PO/PTF |
| PET/Tie/ionomer/PA/EVOH/PA/Del/PTF | PET/Tie/EVA/Tie/PA/EVOH/PA/Del/PO/PTF |
| Paper//tie/PE/tie/EVOH/EVA/PTF | Paper//tie/PE/tie/EVA/PTF |
| PE/tie//Paper//tie/PTF | PET/tie//Paper//tie/PTF |
| Foil//tie/PET/PTF | PP/tie//Paper//tie/PTF |
| Foil//tie/ionomer/tie/PT; | PE/tie//Foil//tie/PTF |
| PP/tie//Foil//tie/PTF | PET/tie//Foil//tie/PTF |

Generally, the polyester may be formed into an easily handled shape (such as pellets) from the polymerization melt, which may then be used to form a film or sheet.

The difference between a sheet and a film is the thickness, but, as the thickness of an article will vary according to the needs of its application, it is difficult to set a standard thickness that differentiates a film from a sheet. Accordingly, the terms “film” and “sheet” are synonymous and used interchangeably herein. Nevertheless, when necessary to draw a distinction, a sheet is defined herein as having a thickness greater than about 0.25 mm (10 mils). Preferably, the thickness of a sheet is from about 0.25 mm to about 25 mm, more preferably from about 2 mm to about 15 mm, and even more preferably from about 3 mm to about 10 mm. In a preferred embodiment, the sheets herein have a thickness sufficient to cause the sheet to be rigid, which generally occurs at about 0.50 mm and greater. However, sheets thicker than 25 mm, and thinner than 0.25 mm may be formed. Sheets can be used, for example, in thermoforming articles.

Correspondingly, when necessary to draw a distinction, a film is defined herein as having a thickness that is less than about 0.25 mm.

Films and sheets may be formed by any process known in the art, such as extrusion, compression, solution casting or injection molding. The parameters for each of these processes will be determined by the viscosity characteristics of the polyester and the desired thickness of the article. Coextruded cast sheet with amorphous or crystalline PET with neat or impact modified ethylene copolymers may also be made.

A film or sheet is preferably formed by extrusion. Extrusion is particularly preferred for formation of “endless” products that emerge as a continuous length. For example, see PCT Application Publications WO 96/38282 and WO 97/00284, which describe the formation of thermoplastic sheets by melt extrusion.

In extrusion, the polymeric material, whether provided as a molten polymer or as plastic pellets or granules, is fluidized and homogenized. This mixture is then forced through a suitably shaped die to produce the desired cross-sectional shape of the article. The extruding force may be exerted by a piston or ram (ram extrusion), or by a rotating screw (screw extrusion), which operates within a cylinder in which the material is heated and plasticized and from which it is then extruded through the die in a continuous flow. Single screw, twin screw and multi-screw extruders may be used as known in the art. Different kinds of die are used to produce different products, such as sheets and strips (slot dies) and hollow and solid sections (circular dies). In cast film extrusion, slot dies are used. Blown film extrusion uses circular dies and the film produced is a tubular film. The tubular blown film may be further processed as a tubular film, or it may be slit lengthwise to provide a planar film. In this manner, films and sheets of different widths and thickness may be produced. After extrusion, the polymeric film or sheet is taken up by rollers, cooled and taken off by means of suitable devices which are designed to prevent any subsequent deformation thereof. If the film or sheet is required to have a textured or matte surface, the final roller is provided with an appropriate embossing pattern.

Planar multilayer films may be prepared by coextrusion by connecting multiple extruders processing the corresponding materials, generally in the form of granulates, to a slot die. Blown film coextrusion of multilayer films or sheets may be carried out by connecting multiple extruders processing the corresponding materials, generally in the form of granulates, to a circular or annular die to form a tubular multilayer film by blown film methods generally known in the art.

Films obtained from polymer compositions as described herein show excellent mechanical properties. For example, the compositions may be formed into films or sheets by extrusion through either slot dies and rapidly cooled by contact with metal rolls held at or below Tg to produce a first article including film or sheet or blown film or sheet. The article can have a surface area to thickness ratio greater than about 254,000:1 or greater than about 100,000:1 or greater than about 2540:1 or greater than about 1000:1.

Regardless of how the film or sheet is formed, it may be subjected to uniaxial or biaxial orientation by stretching in the machine direction, in the transverse direction, or in both directions after formation. The length or width after stretching may be 15 times or 10 times or 5 times or 2 times the original length or width.

The machine direction stretch is initiated in forming the article simply by rolling out and taking it up. This inherently stretches the film or sheet in the direction of take-up, orienting some of the polymer chains. Although this strengthens the article in the machine direction, it allows it to tear easily in the direction at right angles to the machine direction because all of the polymer chains are oriented in one direction. Therefore, biaxially-stretched articles are preferred for certain uses where uniform product is desired, but also where an improved barrier is desired. Biaxial stretching orients the polymers and any fillers or fibers compounded with them parallel to the plane of the article, but leaves the polymers, fillers or fibers randomly oriented within the plane thereof. This provides superior tensile strength, flexibility, toughness, barrier and shrinkability, for example, in comparison to non-oriented articles. It is desirable to stretch the article along two axes at right angles to each other. This increases tensile strength and elastic modulus in the directions of stretch. It is most desirable for the amount of stretch in each direction to be approximately equivalent, thereby providing similar properties or behavior within the article when tested from any direction.

In biaxial orientation, the material is stretched while heating in the transverse direction simultaneously with, or subsequently to, stretching in the machine direction. Biaxial orientation may be obtained by any process known in the art such as by tenter frame orientation, which is well known in the art. Briefly, orientation in the machine direction is accomplished by passing the heated film through a section of rolls in parallel arrangement wherein the take-up roll is driven at a faster rate than the first feed rolls. The transverse orientation is accomplished by passing the heated film through a tenter frame having a chain of tenter clips on each side of the film. The film is directed between the parallel rows of tenter clips and these tenter clips grasp the edges of the material and move outwardly to stretch the film transversely. Shrinkage can be controlled by holding the article in a stretched position and heating for a few seconds before quenching. This heat stabilizes the oriented film or sheet, which then may be forced to shrink only at temperatures above the heat stabilization temperature.

Alternatively, the coextruded multilayer structure may be produced and optionally oriented by blown film extrusion using a double or triple bubble process, which can comprise the steps of coextruding a tubular multilayer film structure comprising the layers described above, cooling the coextruded tubular multilayer film structure in a first bubble, mono- or bi-axially orienting the coextruded tubular multilayer film structure under heating in a second bubble, and optionally relaxing the mono- or bi-axially oriented coextruded tubular multilayer film structure under heating in a third bubble. This triple bubble process allows for the manufacture of coextruded multilayer structures having excellent barrier properties as well as good mechanical properties, in combination with other functional layers. A more detailed description of a typical triple bubble process can be found in U.S. Patent Application Ser. No. 62/108,636 and the corresponding Intl. patent Appln. Publn. No. WO2016/123209.

The multilayer structure also may be prepared by applying to the surface of a substrate one or more layers by (co)extrusion coating, for example, wherein the sealant composition and additional layer composition(s) such as an inner layer are coextruded onto a film that provides the external layer. Alternatively, inner layer composition(s) may be applied as a molten curtain between a first substrate comprising a polymeric film, paper, or metal foil that provides the external structure layer and a second substrate such as a film comprising the sealant composition by well-known extrusion lamination techniques. Extrusion coating and extrusion lamination are useful for preparing multilayer structures in which the external layer substrate is reverse printed, providing a multilayer structure with a printed or ink layer in the interior of the multilayer structure.

The polymeric film or sheet may be combined with other polymeric materials during extrusion and/or finishing to provide laminates or multilayer sheets with improved characteristics, such as water vapor resistance. A multilayer or laminate sheet may be made by any method known in the art, and may have as many as five or more separate layers joined together by heat, adhesion and/or a tie layer, as known in the art. In some instances, the multilayer film structure can be applied to a surface of a substrate as part of a continuous manufacturing process. In a continuous process, the surface of the substrate and/or the protective film is heated and the film adhered to the substrate in a separate operation. For example, the film may be applied to a substrate using a heated nip roll.

The above extrusion processes can be combined with a variety of post-extrusion operations for expanded versatility. Such post-forming operations include altering round to oval shapes, stretching the sheet to different dimensions such as by thermoforming, machining and punching and the like.

Films can be used to prepare packaging materials such as containers, pouches and lidding. Those cast films or sheets that are nearly amorphous may be further thermoformed into articles and structures followed by heat treatment. The thermoformed articles can be prepared by any means known to one skilled in the art, for example by heating the amorphous sheet to a temperature that is above the glass transition temperatures (Tg) and below the melting points of the polymer compositions in the multilayer sheet; stretching the sheet by vacuum or pressure forming using a mold to provide a stretched article; and cooling the stretched article to provide a finished article. The stretched article may be optionally heat treated during the forming step to provide greater crystallization and then cooled in a second step.

Alternatively, shaped articles can be prepared by rotary molding where the sheet (mono or multilayer) comes from the extruder in molten state and is cast on top of rotating cylinders where the molds as shaped depressions are located. The shaped articles are formed by vacuum forming and the formed sheet cools down during the time it is in contact with the drum.

A film or sheet could be thermoformed to produce a concave surface used as a container or packaging material such as a tray, cup, can, bucket, tub, box, bowl, or blister pack. Thermoformed articles may be combined with additional elements, such as a generally planar film sealed to the thermoformed article that serves as a lid (a lidding film) to prepare a package.

The multilayer structures are particularly useful for packaging applications, and can be formed into packages by the many methods known to those skilled in the art. The term “package” includes any container that is meant to be sealed most of the time, especially before the contents are used, against ambient conditions such as air and/or moisture, and/or loss of the package's content by evaporation, and includes lidding applications (e.g., trays or containers covered by a removable lidding film). The package may be designed so that the seal against ambient conditions may be broken permanently as by cutting or tearing to open a sealed bag, or may be meant to remain sealed while in use, e.g., gel packs that are heated and applied as heating pads, or pouches where the contents are dispensed through a fitment or an opening in the pouch. Alternatively, the packaging article may be peelably sealed, wherein the package can be opened by peeling the film from a substrate or by pealing apart two layers of the sealant. These packages are preferably made from the multilayer films disclosed herein, in which the heat-sealable polyester compositions described herein comprise the “sealing layer”, i.e., the layer which forms a heat-seal. Such packages are extremely useful for packaging foods because of the oxygen barrier functionality and good flavor/odor barrier with non-scalping and low impartation, are formable and clear. Thus, they are especially preferred for packaging where taste and/or smell retention is important. The packages may be flexible bags which are sealed, such as solid or liquid food containers, intravenous bags, pouches, dry food containers (cereal liners, cracker liners in boxes), chemical pouches, stand-up pouches, cereal pouches, lidding, pet food bags, etc., among others.

The multilayer structures can be useful in a variety of packaging applications as packaging materials. They may also be used as industrial films such as masking or protective films whereby a film is thermally laminated to a substrate, such as glass, metal including foil, or polyester or acrylic, and peeled off when surface protection is no longer required; or as a structural component in insulation sheeting.

The packaging materials may also be processed further by, for example but not limited to, printing to provide color and graphics including alphanumeric text and/or pictures, embossing, and/or coloring to provide a packaging material that provides information to the consumer about the product therein and/or provides a pleasing appearance of the package. Such further processing is typically carried out before a lamination process described above, but may also be carried out after the lamination.

The packaging materials may be formed into packages, such as pouches, by standard methods well known in the art. Generally, pouches may be prepared by overlaying two or more film surfaces and heat sealing them together.

The invention further provides a process for heat-sealing two thermoplastics wherein two thermoplastic surfaces are sealed to one another by the application of heat and pressure. The improvement resides in at least one of the thermoplastic surfaces comprising a polyester composition comprising PTF homopolymer or copolymer. The foregoing discussion of the polyester composition applies equally to such surfaces. For example, packaging articles such as pouches may be prepared by overlaying two film surfaces, each comprising a PTF composition as described herein, and applying heat and pressure to seal the two surfaces together. The film surfaces may be two different portions of a single film comprising a sealant layer comprising PTF, wherein the film is folded or otherwise overlaid so that one portion of the film overlays and contacts another portion of the same film and the overlaying portions are heat sealed. The portions of the film in contact may both comprise the PTF composition in a face-to face manner, or one portion of the film comprising PTF overlays a portion of the film that does not comprise PTF, such as a lap seal. Alternatively, the thermoplastic surfaces may be different, such as for example, two separate films, or a film and a sheet or shaped article such as a tray, cup or bowl.

The invention also provides an article wherein two thermoplastic surfaces have been heat-sealed, and at least one of said thermoplastic surfaces comprises a polyester composition comprising a PTF homopolymer or copolymer. Both surfaces of the article(s) to be heat-sealed may have a surface of the PTF polyester composition as described herein, though applications in which only one surface comprises the PTF compositions are also contemplated, e.g., lidding applications. The foregoing discussion of the PTF composition applies equally to such thermoplastic surface(s). If both surfaces to be heat-sealed comprise the PTF composition, then preferably a composition of these two surfaces is made from the same monomers, and more preferably the surfaces are made from essentially the same polymer.

More than two surfaces may be sealed together, for example, three films may be sealed together as long as all the surfaces being sealed are of the composition described herein. Preferably, the heating of the areas to be sealed is done by thermal conduction from a hotter material, e.g., sealing bar(s) or roller(s), or by microwave heating, dielectric heating, ultrasonication, etc.

The multilayer films can be useful in packaging applications as packaging materials that, for example, include both peelable and permanent seals. Also, for example, the multilayer film can be applied to another packaging film such as an oriented film disclosed above to produce a second multilayer film. The multilayer film or the second multilayer film can be sealed to itself or to another film or to each other at a first, lower temperature to form a frangible seal. The multilayer film or the second multilayer film can also be sealed to itself or to another film or to each other at a second, higher temperature to form a permanent seal.

The first and second packaging substrates may be the same or different. For example, the first and second films may be first and second portions of a unitary film. In addition, the other film(s) may be the same or different from each other, and they may also be the same or different from the first and second film. For example, the other film(s) may also be first and second portions of a unitary film.

The packages that include a permanent and a peelable seal are useful, for example, to form an easily peelable opening of well-defined size, while the remainder of the package retains its integrity. An opening of well-defined size can promote easy pouring of the package contents. In this embodiment, the peelable seal forms at least a portion of a boundary between the inside of the package and the outside of the package. A permanent seal, a fold of packaging material, a lap seal, or the like, or combinations thereof, may form the remainder of the boundary. In this manner, the size of the opening in the package is defined by the portion of the package's perimeter that is peelably sealed.

For example, polymers can be coextruded to produce a multilayer film containing a layer of the sealant to produce a sealant-containing film. The sealant-containing film can be applied or laminated to a second film of oriented polyester or oriented polypropylene to produce a second multilayer film. The multilayer film (or the second multilayer film) can comprise a PTF composition disclosed above. After folding, two sides of each of the multilayer film or the second multilayer film can be sealed at their edges to produce a package having an opening. A sealed perimeter of a package is produced and defined. A multilayer film (or the second multilayer film) can also be or superimposed on another sheet of the same film followed by sealing three sides at the edges to produce a package having an opening thereby producing a seal and defining a sealed perimeter of a package. Alternatively, the multilayer film (or the second multilayer film) can be superimposed on another film such as a polyester film. The edges along three sides of the multilayer film are sealed to produce a package having an opening thereby producing a seal and defining a sealed perimeter of a package with the opening. The compartment(s) formed on the inside of the package can be filled with one or more ingredients including solid, fluid, or gas ingredients. The opening(s) can then be sealed. One or more portions of the film(s) on the perimeter of the package can be sealed to produce one or more peelable or at least partially peelable seals to allow opening of the package and access to the contents. In some embodiments, the film surfaces can be overlaid to form a package, the package may be filled and then sealed in a continuous operation in a form-fill-and-seal machine known in the art.

The amount of pressure used to produce a heat seal may vary from that needed to contact the two (or more) surfaces to be sealed, for example finger pressure to pressure applied by presses or rollers, e.g., up to about 90 pounds per square inch of sealing bar. The heating may occur before or simultaneously with the application of pressure. Although pressure may be applied before heating, it will normally not be effective to form a heat seal until the heating is carried out. Parenthetically, typical processes for forming a seal with pressure-sensitive adhesives are different in this respect.

The temperature of the heat-sealable polyester composition sealing surface, which is being sealed, will generally be above the Tg and less than the Tcg of the PTF composition. Since much commercial heat-sealing is carried out on high-speed lines, the lower the temperature needed to give a seal of sufficient strength, the faster the line may be run, since it will take less time to heat the sealing surface to the required temperature.

Notable methods of heat-sealing include:
1. A process for heat-sealing two thermoplastics wherein the two thermoplastic surfaces are sealed to one another by the application of heat and pressure, wherein at least one of said thermoplastics comprises a polyester composition comprising poly(trimethylene furandicarboxylate) homopolymer or copolymer, or copolymer formed from the respective monomers.
2. Process 1, wherein the second thermoplastic surface comprises poly(trimethylene furandicarboxylate), poly(ethylene terephthalate), poly(trimethylene terephthalate), polyethylene, polypropylene, high-impact polystyrene, expanded polystyrene, acrylic homopolymer or acrylic copolymer, polycarbonate, polysulfone, polyvinyl chloride, polychlorotrifluoroethylene, polyacrylonitrile homopolymer or copolymer, polyacetal, or polyacetal copolymer.
3. Process 2, wherein the second thermoplastic surface comprises poly(trimethylene furandicarboxylate), poly(ethylene terephthalate), or poly(trimethylene terephthalate).

Articles in which two thermoplastic surfaces have been heat-sealed include, for example, injection, compression, thermoformed or blow-molded parts; monolayer and multilayer films and sheets and packages made therefrom (also as described above); foil, paper or paperboard coated with the heat-sealable PTF composition herein and packages made therefrom.

The article comprising a sealant layer comprising PTF can be used for any suitable application, including, but not limited to food and drug packaging, or packaging medical devices, personal care products, electronics and semiconductors, paints or chemicals.

In particular, the polymers as described herein are suitable for manufacturing:
Multilayer uni-axially and bi-axially oriented films;
pouches or sachets for containing liquids such as water, flavored beverages, condiments, yogurt, pudding, and other material for human or animal consumption, or soaps, detergents, lotions and other personal care products;
pouches or bags for dry foods such as corn flakes or other breakfast cereals, noodles, rice, beans, dried vegetables and optionally seasoning for reconstitution with water, coffee beans or ground coffee, dry or moist snacks such as nuts, candy, cookies, chips and the like; and other edible food items such as dairy powders;
cling or shrink films for use with foodstuffs;
thermoformed packaging or containers, both mono- and multi-layered, for foodstuffs, as in containers for milk, yogurt, pudding, meats, beverages, prepared meals, and the like;
blister packs for unit doses of pharmaceuticals, nutraceuticals, vitamins and the like;
coatings obtained using extrusion coating or powder coating on substrates comprising metals not limited to such as stainless steel, carbon steel, aluminum, such coatings may include binders, agents to control flow such as silica, alumina; and
multilayer laminates with rigid or flexible backings such as for example paper, plastic, aluminum, or metallic films.

The multilayer structures described above may be incorporated into packages, such as lidded containers, by standard methods well known in the art. The multilayer structures can be useful as lidding materials for containers. Packages or containers include molded, pressed or thermoformed containers comprising a structure and/or multilayer structures disclosed above. In addition to the materials listed above, the rigid containers may contain other materials such as, for example, a polymeric resin modified by various additives to provide a modified polymeric blend suitable for preparing containers, such as toughened crystalline CPET. The materials can also be modified with other additives such as denesting agents and can also be modified with additives such as fillers. The containers can be multilayer containers containing an inside product contact layer comprising the PTF composition, an inner layer that can be a barrier or bulking layer and an outer or abuse layer. For example, the container may comprise a container comprising a structure comprising at least one layer of foil, paperboard, glass, high-density polyethylene (HDPE), polypropylene (PP), high-impact polystyrene (HIPS), expanded polystyrene (EPS), acrylic homopolymer or acrylic copolymer, polycarbonate, polysulfone, amorphous polyethylene terephthalate (APET), crystalline polyethylene terephthalate (CPET), polyvinyl chloride (PVC), polychlorotrifluoroethylene (PCTFE), polyacrylonitrile homopolymer or copolymer, polyacetal, or polyacetal copolymer and an inside surface layer comprising the PTF composition. The container may be heat sealed to a peelable lid that may or may not comprise a sealant layer comprising the PTF composition on the inside surface.

Further provided is a package comprising (1) a container comprising a structure comprising at least one layer of foil, paperboard, glass, high-density polyethylene (HDPE), polypropylene (PP), high-impact polystyrene (HIPS), expanded polystyrene (EPS), acrylic homopolymer or acrylic copolymer, polycarbonate, polysulfone, amorphous polyethylene terephthalate (APET), crystalline polyethylene terephthalate (CPET), polyvinyl chloride (PVC), polychlorotrifluoroethylene (PCTFE), polyacrylonitrile homopolymer or copolymer, polyacetal, or polyacetal copolymer; and (2) a peelable lid comprising a multilayer structure as described above comprising the PTF composition on the inside surface. A notable package comprises a container comprising APET or CPET and a peelable lid comprising a sealant layer comprising a PTF composition described herein.

Such containers may be used to package products such as yogurts, puddings, custards, gelatins, fruit sauces (for example, applesauce) and the like. They may also be used to package cheese spreads and dips. Packages as described herein may also be used as packages for meats and frozen or refrigerated meals. Packages of this invention also include packages for dry foods such as noodles and seasoning for reconstitution with water. They can also be used to package dry snacks such as cookies, chips and the like.

The concepts disclosed herein will be further described in the following examples, which do not limit the scope of the invention described in the claims.

### EXAMPLES

### Materials

PTF: Polytrimethylene-2,5-furandicarboxylate was prepared according to the methods described below.
PET: Poly(ethylene terephthalate) PET AA72 polyethylene terephthalate) 0.82 IV (contains 1.9 mol % isophthalic acid) was obtained from NanYa.
PTT: Poly(trimethylene terephthalate) (PTT) was received from DuPont under the tradename Sorona® J1156.
   All materials were dried for a minimum of 6 hours under vacuum at 120° C. with nitrogen flow prior to processing.
   Synthesis of High Molecular Weight Poly(trimethylene-2,5-furandicarboxylate)
   Step 1:Preparation of a PTF Pre-Polymer by Polycondensation of bioPDO™ and FDME

2,5-Furandimethylester (2557 g), 1,3-propanediol (1902 g), preferably biologically-derived bioPDO™, titanium (IV) isopropoxide (2 g), Dovernox™-10 (5.4g) were charged to a 10-lb stainless steel stirred autoclave (Delaware Valley Steel 1955, vessel number XS 1963) equipped with a stirring rod and condenser. A nitrogen purge was applied and stirring was commenced at 30 rpm to form a slurry. While stirring, the autoclave was subject to three cycles of pressurization to 50 psi of nitrogen followed by evacuation. A weak nitrogen purge (˜0.5 L/min) was then established to maintain an inert atmosphere. While the autoclave was heated to the set point of 240° C., methanol evolution began at a batch temperature of 185° C. Methanol distillation continued for 120 minutes during which the batch temperature increased from 185° C. to 238° C. When the temperature leveled out at 238° C., a second charge of titanium (IV) isopropoxide (2g) was added. At this time, a vacuum ramp was initiated that during 60 minutes reduced the pressure from 760 torr to 300 torr (pumping through the column) and from 300 torr to 0.05 torr (pumping through the trap). The mixture was held at a pressure of 0.05 torr with stirring for 5 hours, after which nitrogen was used to pressurize the vessel back to 760 torr.

The formed polymer was recovered by pushing the melt through an exit valve at the bottom of the vessel and into a water quench bath. The thus-formed strand was strung through a pelletizer equipped with an air jet to dry the polymer. The polymer strand was cut into pellets about ¼ inch long and about ⅛ inch in diameter. Yield was approximately 2724 g. T_{g} was around 58° C. (DSC, 5° C./min, second heat), Tₘ was around 176° C. (DSC, 5° C./min, second heat). ¹H-NMR (TCE-d) 6: 7.05 (s, 2H), 4.40 (m, 4H), 2.15 (m, 2H). Mₙ (SEC) about 10 300 D, PDI 1.97, and IV approximately 0.55 dL/g.

### Step 2: Preparation of High Molecular Weight PTF Polymer by Solid Phase Polymerization of the PTF Pre-Polymer of Step 1

In order to increase the molecular weight of the PTF pre-polymer, solid phase polymerization was conducted using a heated fluidized nitrogen bed. The quenched and pelletized PTF pre-polymer was initially crystallized by placing the material in an oven and heating the pellets under a nitrogen purge to 120° C. for 240 minutes. At this time the oven temperature was increased to around 168° C. and the pellets were held at this temperature under a nitrogen purge for 96 h, to build molecular weight. The oven was turned off and the pellets were allowed to cool. The obtained pellets had a measured IV of about 0.99 dL/g.

### Film Preparation

### Preparation of PTF, PTT or PET Film by Extrusion

For film extrusion, pellets were fed into a 30 mm W&P (Werner & Phleiderer) twin screw extruder equipped with a 60/200 mesh filter screen and a 25-centimeter-wide film casting die. The feeder, extruder barrel sections (11 in total) and die were all set at 230° C. for PTF, 240° C. for PTT and 270° C. for PET. A vacuum port was used on barrel section 6. The feed rate was 10 pounds per hour and the extruder screw speed was 125 rpm. The panel melt temperature was measured at 233° C. for PTF (242° C. for PTT and 275° C. for PET). The film was collected after being cast on a cooling drum with a temperature set point of 40° C., the measured film thickness was about 0.03 millimeter and the width was about 22 centimeters. Following the casting, the film was cut into smaller samples for further testing.

Films of PTF and PTT were stored in a freezer at −20° C. prior to testing. PET films were stored under ambient conditions.

### Heat Seal and Peel Strength Test Methods

A specimen cutter in accordance with ASTM D882-91 was used to cut samples (25.4 mm×127 mm; 1 in×5 in) from cast films in preparation for sealing. Heat seals were made using a one-inch top bar-only heated sealer with Mylar slip sheet, 40 psig seal force, and 0.5 second dwell. Seals were aged for 24 hours at 22° C. (72° F.) and 50% RH prior to testing. Seals strength was tested as described in ASTM-F88. The seal strength results set forth in Tables 1 through 4 represent the average of 3 to 5 peel tests.

### Example 1

### Heat Seal of PTF to PTF

PTF film in monolayer form was sealed to another monolayer film of PTF. The seal strength of PTF sealed to PTF over the temperature range of 80-180° C. is summarized in Table 1. When sealed to itself, PTF formed a strong lock seal with seal strengths exceeding 1000 gram-force/inch. In the heat seal configuration described, the observed onset or heat seal initiation temperature was between 120 and 130° C. The observed seal window is broader than is typical for polyesters and extends at least up to 180° C.

TABLE 1

| Seal Bar Setpoint | Seal Strength | |
|---|---|---|
| Temperature (° C.) | gram-force/inch | N/15 mm |
| 80 | 33.25 | 0.193 |
| 90 | 26.95 | 0.156 |
| 100 | 27.3 | 0.158 |
| 110 | 59.2 | 0.343 |
| 120 | 106.2 | 0.615 |
| 130 | 1376 | 8.00 |
| 140 | 1632 | 9.45 |
| 150 | 1322 | 7.65 |
| 160 | 2554 | 14.8 |
| 170 | 2645 | 15.3 |
| 180 | 2665 | 15.4 |

### Example 2

### Heat Seal of PTF to PTT

PTF film in monolayer form was sealed to a monolayer film of PTT with the PTF layer on the heated side of the seal bar, with the results summarized in Table 2. PTF formed strong lock seals to PTT at lower temperatures than it seals to itself. In the heat seal configuration described the observed onset or heat seal initiation temperature was less than 90° C. Seal temperatures above about 130° C. and especially above 150° C. resulted in lower seal strength.

TABLE 2

| | Seal Strength | |
|---|---|---|
| Seal Bar Setpoint | | N/15 |
| Temperature (° C.) | gram-force/inch | mm |
| 90 | 1207 | 6.99 |
| 100 | 2214 | 12.8 |
| 110 | 1849 | 10.7 |
| 120 | 1240 | 7.18 |
| 130 | 1537 | 8.90 |
| 140 | 1661 | 9.62 |
| 160 | 885 | 5.22 |
| 180 | 970 | 5.62 |

### Example 3

### Heat Seal of PTF to PET

PTF film in monolayer form was sealed to a monolayer film of amorphous PET with the PTF layer on the heated side of the seal bar. The results are summarized in Table 3. PTF formed a peelable seal in the heat seal configuration described between 110-130° C. with a heat seal initiation temperature of about 130° C. Sealability was observed at temperatures up to 160° C.

TABLE 3

| Seal Bar Setpoint | Seal Strength | |
|---|---|---|
| Temperature (° C.) | gram-force/inch | N/15 mm |
| 90 | 33.8 | 0.196 |
| 100 | 74.7 | 0.433 |
| 110 | 590 | 3.42 |
| 120 | 901 | 5.22 |
| 130 | 1183 | 6.85 |
| 140 | 1290 | 7.47 |
| 160 | 1766 | 10.23 |

### Aging Tests

The effects of aging of the film on the performance of heat seals made by sealing two monolayer PTF films together are summarized in Table 4. Film samples were aged at 22° C. (72° F.) and 50% RH prior to sealing for the time indicated in Table 4. The seals were tested one day after heat sealing, except as indicated in Table 4.

TABLE 4

| | Seal Bar Setpoint | | | | |
|---|---|---|---|---|---|
| Film aged before sealing | Temperature (° C.) | 120 | 130 | 150 | 180 |
| 0 day | gram-force/inch | 1288 | 1539 | 3492 | 4019 |
| | Std. dev. | 215 | 218 | 783 | 2042 |
| | N/15 mm | 7.46 | 8.91 | 20.2 | 23.3 |
| | Std. dev. | 1.25 | 3.31 | 4.54 | 11.8 |
| 1 day | gram-force/inch | 1248 | 1025 | 4823 | 2995 |
| | Std. dev. | 221 | 249 | 909 | 794 |
| | N/15 mm | 7.23 | 5.94 | 27.9 | 17.35 |
| | Std. dev. | 1.28 | 1.44 | 5.26 | 4.60 |
| 7 days | gram-force/inch | 1154 | 1525 | 2964 | 3936 |
| | Std. dev. | 222 | 272 | 1603 | 1083 |
| | N/15 mm | 6.68 | 8.83 | 17.2 | 22.8 |
| | Std. dev. | 1.28 | 1.58 | 9.28 | 6.27 |
| 14 days | gram-force/inch | 1782 | 1913 | 3488 | 5313 |
| | Std. dev. | 327 | 218 | 946 | 555 |
| | N/15 mm | 10.3 | 11.1 | 20.2 | 30.8 |
| | Std. dev. | 1.89 | 1.26 | 5.48 | 3.21 |
| 28 days | gram-force/inch | 908 | 904 | 1652 | 3836 |
| | Std. dev. | 292 | 279 | 516 | 1833 |
| | N/15 mm | 5.26 | 5.23 | 9.57 | 22.2 |
| | Std. dev. | 1.69 | 1.62 | 3.00 | 10.6 |
| 2 months | gram-force/inch | 1314 | 986 | 3488 | 5313 |
| | Std. dev. | 337 | 783 | 516 | 1832 |
| | N/15 mm | 7.61 | 5.71 | 20.2 | 30.8 |
| | Std. dev. | 1.95 | 4.53 | 2.99 | 10.7 |
| 4 months | gram-force/inch | 1021 | 1348 | 2883 | 4801 |
| | Std. dev. | 117 | 286 | 1858 | 330 |
| | N/15 mm | 5.91 | 7.81 | 16.7 | 27.8 |
| | Std. dev. | 0.68 | 1.66 | 10.8 | 1.91 |
| 6 months | gram-force/inch | 1579 | 2035 | 3053 | 1906 |
| | Std. dev. | 475 | 386 | 1008 | 1337 |
| | N/15 mm | 9.14 | 11.8 | 17.7 | 11.0 |
| | Std. dev. | 2.75 | 2.24 | 5.84 | 7.74 |
| Film aged 14 days + | gram-force/inch | 909 | 2047 | 5222 | 2756 |
| seal aged 14 days | Std. dev. | 304 | 128 | 120 | 1260 |
| | N/15 mm | 5.26 | 11.9 | 30.2 | 16.0 |
| | Std. dev. | 1.76 | 0.73 | 0.69 | 7.30 |

Sealability (formation of seals with strength of 1000 g/in or greater) was retained over the course of the aging study. The high error of the data as reflected in the standard deviations is due to different failure modes in the three replicates tested (peel, tear, or seal break) for each seal condition.

Having thus described and exemplified the invention with a certain degree of particularity, it should be appreciated that the following claims are not to be so limited but are to be afforded a scope commensurate with the wording of each element of the claim and equivalents thereof.

1. An article comprising a sealant layer, said sealant layer comprising a heat-sealable polyester composition having an amorphous processing window ranging from a glass transition temperature, Tg, in the range of about 40 to about 70° C., to a peak crystallization temperature from the amorphous state Tcg in the range of about 70 to about 150° C., wherein the heat-sealable polyester composition comprises a polymer comprising poly(trimethylene furandicarboxylate).

2. The article of claim 1, comprising a multilayer gas barrier film.

3. The article of claim 1, comprising a multilayer structure for a package, comprising in order from outside the package to inside the package, an external layer, optionally at least one inner layer that is a bulking layer, barrier layer, adhesion layer or delamination layer, and the sealant layer.

4. The article of claim 1, wherein the multilayer structure comprises the following layer structure positioned in order from the outside to the inside:
an outside surface layer comprising polyester, polyamide, polystyrene, polycarbonate, poly(methyl methacrylate), cyclic olefin copolymer, polypropylene, high density polyethylene, or combinations thereof;
an optional layer comprising a first adhesion layer;
an optional gas barrier layer comprising ethylene vinyl alcohol copolymer, cyclic olefin copolymers, polyvinyl acetate, or blends thereof with polyethylene, polyvinyl alcohol, or polyamide;
an optional layer comprising a second adhesion layer;
an optional bulking layer comprising polyethylene homopolymer or copolymer, polypropylene homopolymer or copolymer, or an ethylene copolymer comprising copolymerized units derived from ethylene and at least one additional polar comonomer;
an optional layer comprising a third adhesion layer; and
the sealant layer, wherein the sealant layer is an inside surface layer.

5. The article of claim 1, wherein the multilayer structure comprises the following layer structure positioned in order from the outside to the inside:
an outside surface layer comprising polyester;
a layer comprising a first adhesion layer;
a gas barrier layer comprising ethylene vinyl alcohol copolymer sandwiched between two layers of polyamide;
a layer comprising a second adhesion layer;
a bulking layer;
an optional layer comprising a third adhesion layer; and
the sealant layer, wherein the sealant layer is an inside surface layer.

6. The article of claim 1, wherein the multilayer structure comprises the following layer structure positioned in order from the outside to the inside:
an outside surface layer comprising polyester, polyamide, polystyrene, polycarbonate, poly(methyl methacrylate), cyclic olefin copolymer, polypropylene, high density polyethylene, or combinations thereof, preferably polyester such as polyethylene terephthalate;
a polyamide layer in direct contact with the delamination layer;
a delamination layer in direct contact with the polyamide layer comprising an anhydride-modified polymer comprising a base polymer comprising a polyethylene homopolymer or copolymer, polypropylene homopolymer or copolymer, or an ethylene copolymer comprising copolymerized units derived from ethylene and at least one additional polar comonomer, preferably ethylene vinyl acetate copolymer, ethylene alkyl (meth)acrylate copolymer, wherein the base polymer is grafted with up to 1 weight % of an unsaturated dicarboxylic acid anhydride, preferably maleic anhydride; or an acid copolymer or ionomer thereof; wherein the adhesion between the polyamide layer and the delamination layer is from 0.1 to 10 N/15 mm, preferably from 2 to 8 N/15 mm; and
the sealant layer, wherein the sealant layer is an inside surface layer.

7. The article of claim 1, wherein the sealant layer is bonded to a layer comprising poly(trimethylene furandicarboxylate), poly(ethylene terephthalate), poly(trimethylene terephthalate), foil, paperboard, glass, polyethylene, polypropylene, high-impact polystyrene, expanded polystyrene, acrylic homopolymer or acrylic copolymer, polycarbonate, polysulfone, polyvinyl chloride, polychlorotrifluoroethylene, polyacrylonitrile homopolymer or copolymer, polyacetal, or polyacetal copolymer.

8. The article of claim 7, wherein the sealant layer is bonded to a layer comprising poly(trimethylene furandicarboxylate), poly(ethylene terephthalate), or poly(trimethylene terephthalate).

9. The article of claim 1, wherein two thermoplastic surfaces have been heat-sealed, wherein at least one of said thermoplastic surfaces comprises the sealant layer, and wherein the polymer comprises poly(trimethylene furandicarboxylate) homopolymer or copolymer, or a copolymer formed from the respective monomers.

10. The article of claim 1, wherein the face of the sealant layer is peelably adhered to a substrate with a peel strength from about 200 to about 1000 g-force/inch.

11. The article of claim 10, wherein the peel strength is from about 400 to about 900 g-force/inch.

12. The article of claim 10, wherein the substrate is foil, paperboard, glass, high-density polyethylene, polypropylene, high-impact polystyrene, expanded polystyrene, acrylic homopolymer or acrylic copolymer, polycarbonate, polysulfone, amorphous polyethylene terephthalate, crystalline polyethylene terephthalate, polyvinyl chloride, polychlorotrifluoroethylene, polyacrylonitrile homopolymer or copolymer, polyacetal, or polyacetal copolymer.

13. The article of claim 1, wherein the face of the sealant layer is adhered to a substrate layer with a peel strength greater than 1000 g-force/inch.

14. The article of claim 13, wherein the substrate layer comprises poly(trimethylene furandicarboxylate), poly(ethylene terephthalate), or poly(trimethylene terephthalate).

15. The article of claim 1, that is a package wherein the heat-sealable polyester composition comprising the polytrimethylene furandicarboxylate polymer composition faces the inside of the package and is in contact with the contents of the package.

16. The article of claim 15, wherein the package comprises a film, sheet, pouch, sachet, bag, thermoformed article, lid, container, blister pack, coated substrate or multilayer laminate.

17. The article of claim 1, that is a package comprising a container comprising a structure comprising at least one layer of foil, paperboard, glass, high-density polyethylene, polypropylene, high-impact polystyrene, expanded polystyrene, acrylic homopolymer or acrylic copolymer, polycarbonate, polysulfone, amorphous polyethylene terephthalate, crystalline polyethylene terephthalate, polyvinyl chloride, polychlorotrifluoroethylene, polyacrylonitrile homopolymer or copolymer, polyacetal, or polyacetal copolymer; and an inside surface layer comprising poly(trimethylene furandicarboxylate).

18. The article of claim 17, wherein the container is heat sealed to a peelable lid that may or may not comprise a sealant layer comprising a PTF composition on the inside surface.

19. The article of claim 1, that is a package comprising (1) a container comprising a structure comprising at least one layer of foil, paperboard, glass, high-density polyethylene, polypropylene, high-impact polystyrene, expanded polystyrene, acrylic homopolymer or acrylic copolymer, polycarbonate, polysulfone, amorphous polyethylene terephthalate, crystalline polyethylene terephthalate, polyvinyl chloride, polychlorotrifluoroethylene, polyacrylonitrile homopolymer or copolymer, polyacetal, or polyacetal copolymer; and (2) a peelable lid comprising a multilayer structure comprising a sealant layer comprising poly(trimethylene furandicarboxylate) on the inside surface.

20. The article of claim 1 that is a pouch, sachet, or bag.
